(19) United States
(12) Patent Application Publication
(10) Pub. No.: US 2025/0263238 A1
(43) Pub. Date: Aug. 21, 2025

(54) DEBRIS CHUTE ASSEMBLY

(71) Applicant: TDR SYSTEMS, INC. t/a CHUTES INTERNATIONAL MANUFACTURING, LLC, Waldorf, MD (US)

(72) Inventors: Hadi C. BOUSTANI, Waldorf, MD (US); Chad HELMER, Battle Ground, WA (US)

(73) Assignee: TDR SYSTEMS, INC. t/a CHUTES INTERNATIONAL MANUFACTURING, LLC, Waldorf, MD (US)

(21) Appl. No.: 19/200,861

(22) Filed: May 7, 2025

Related U.S. Application Data
(63) Continuation-in-part of application No. 18/388,213, filed on Nov. 9, 2023.

(51) Int. Cl. B65G 11/02; B65F 1/14; B65G 11/18

(52) U.S. Cl. CPC B65G 11/02; B65G 11/18; B65F 1/14

(57) ABSTRACT

A debris chute assembly including a plurality of wall members selectively engaged with a scaffold. The plurality of wall members includes a passageway defined in a wall member of the plurality of wall members. A portion of the scaffold is received within the passageway. A flange is also provided on the wall member. The flange is removable securable to the scaffold. The wall member further includes a fastener provided thereon. The debris chute assembly may also include the scaffold which includes a plurality of standards and a plurality of ledgers. The plurality of standards are spaced a distance apart from one another. The plurality of ledgers extend between adjacent standards of the plurality of standards.

### REFERENCE TO RELATED APPLICATIONS

This application is a Continuation-in-Part of U.S. patent application Ser. No. 18/388,213, filed on Nov. 9, 2023; the disclosure of which is incorporated herein by reference.

### TECHNICAL FIELD

The disclosure relates to a debris chute assembly and more particularly pertains to a new debris chute assembly for removing debris from a height during construction or similar activity.

### BACKGROUND ART

The prior art discloses a myriad of debris chutes for use at construction sites or similar to remove debris from a height. It is known, for example, that plywood debris chutes are constructed to mount within scaffolds to form a debris chute. However, such debris chutes are labor intensive to construct, and plywood is not as durable as many types of sheet metal.

U.S. Patent Publication Application No. 2020/0307915 (Stodulka) describes a debris chute comprising wall members and corner members made of sheet metal that hook onto ledgers of a scaffold. Fasteners are not positively described in the specification of this application beyond the hooked portions of the wall members and corner members which hang on ledgers of the scaffold. Without further attachment or locking mechanism, the wall members of the disclosed debris chute are likely to swing due to wind or other forces. Such movement would facilitate damage to the wall members as debris is dropped onto the swinging wall members and facilitate the release of dust or other objects through gaps formed between wall members.

### SUMMARY OF THE INVENTION

There is a need in the art for an improved debris chute assembly. The debris chute assembly disclosed herein includes wall members having a wall flange extending outwardly from one side thereof. The wall members further each include a fastener extending outwardly from the wall flange, where the fastener is configured to receive a tie wire which wraps around such that is circumscribes the standard of the scaffold to secure the wall member to the scaffold. Each wall member further includes a hook or connector defining a passageway in which a ledger of the scaffold is receivable. Certain wall members of the debris chute assembly further include an aperture therein and a door is provided adjacent the aperture. The door is movable between an open position and a closed position. In one embodiment, the door is biased to the closed position or is self-closing.

In one aspect, an exemplary embodiment of the present disclosure may provide a debris chute assembly including a plurality of wall members selectively engageable with a scaffold. A passageway is defined by a wall member of the plurality of wall members. A portion of the scaffold is received within the passageway. A flange provided on the wall member is removably securable to the scaffold. A fastener is provided on the wall member.

In another aspect, an exemplary embodiment of the present disclosure may provide a debris chute assembly including a scaffold having a plurality of standards spaced a distance apart from one another and a plurality of ledgers extending between adjacent standards of the plurality of standards. A ledger of the plurality of ledgers is received within a passageway defined by a wall member of the debris chute assembly. A flange provided on the wall member and a standard of the plurality of standards are removably securable to one another. In another aspect, an exemplary embodiment of the present disclosure may provide that the wall member includes a wall panel having a top, a bottom, and a first side and a second side extending between the top and the bottom. The flange extends outwardly from the first side of the wall panel. In another aspect, an exemplary embodiment of the present disclosure may provide that the wall panel further includes an inner surface and an outer surface extending between the top and the bottom of the wall panel, and that the flange is oriented at an angle greater than 90 degrees relative to the inner surface of the wall panel. In another aspect, an exemplary embodiment of the present disclosure may provide that the wall member includes a wall panel having a top, a bottom and a first side and a second side extending between the top and the bottom, and a connector extending outwardly from an outer surface of the wall panel proximate the top of the wall panel. A passageway is defined by the connector. In another aspect, an exemplary embodiment of the present disclosure may provide that the fastener extends outwardly from an outer surface of the connector. In another aspect, an exemplary embodiment of the present disclosure may further provide a tie wire operably engaged with the fastener. In another aspect, an exemplary embodiment of the present disclosure may provide that the tie wire extends between the portion of the scaffold and the fastener. In another aspect, an exemplary embodiment of the present disclosure may further provide a channel defined in the debris chute assembly. The channel is bounded and defined by the inner surfaces of the wall panel and an inner surface of the flange of all of the plurality of wall members. In another aspect, an exemplary embodiment of the present disclosure may further provide that where the plurality of wall members includes a first wall member and a second wall member. An aperture is defined between an outer surface and an inner surface of the second wall member. The aperture is in fluid communication with the channel of the debris chute assembly. In another aspect, an exemplary embodiment of the present disclosure may provide a door located proximate the aperture defined in the second wall panel. The door is moveable between an open position and a closed position. When the door is the open position access to the channel of the debris chute assembly is enabled and when door is in the closed position access to the channel of the debris chute assembly is restricted. In another aspect, an exemplary embodiment of the present disclosure may further provide a securement mechanism which selectively engages the door to a standard of the plurality of standards. In another aspect, an exemplary embodiment of the present disclosure may further provide where the door is biased into the closed position. In another aspect, an exemplary embodiment of the present disclosure may further provide where the plurality of wall members include a plurality of first wall members, a plurality of second wall members, and at least one third wall member. In another aspect, an exemplary embodiment of the present disclosure may further provide where the plurality of first wall members includes a first flange extending outwardly from first side of the wall panel and a second flange extending outwardly from the second side of the wall panel. In another aspect, an exemplary embodiment of the present disclosure may further provide where the plurality of wall members includes a first lip extending outwardly from first side of the wall panel and a second lip extending outwardly from the second side of the wall panel. In another aspect, an exemplary embodiment of the present disclosure may further provide where the third wall member is a hopper wall member.

In another aspect, an exemplary embodiment of the present disclosure may provide a method of assembling a debris chute assembly. The method includes providing a scaffold and providing a plurality of wall members. The method further includes defining a passageway in each wall member of the plurality of wall members and providing an attachment mechanism proximate a top of each wall member. The method further includes selectively engaging a line with the fastener of a wall member of the plurality of wall members and lowering the wall member of the plurality of wall members onto a portion of the scaffold. The method further includes receiving the portion of the scaffold in the passageway of the wall member and hanging the wall member from the portion of the scaffold. The method further includes hanging the wall member from the portion of the scaffold.

In a further aspect, an exemplary embodiment of the present disclosure may provide the method of assembling a debris chute assembly that includes disengaging the line from the attachment mechanism on the wall member and selectively engaging the line with a fastener on another wall member of the plurality of wall members. The method further includes lowering the another wall member onto another portion of the scaffold via the line, receiving the another portion of the scaffold into the passageway of the another wall member, and hanging the another wall member from the another portion of the scaffold. In a further aspect, an exemplary embodiment of the present disclosure may provide where providing the scaffold further includes spacing a plurality of standards of a scaffold apart from one another and extending a ledger of a plurality of ledgers of the scaffold between adjacent standards of the plurality of standards. In a further aspect, an exemplary embodiment of the present disclosure may provide where the wall member of the plurality of wall members are lowered onto the ledger of the plurality of ledgers, the ledger is received within the passageway of the wall member, and the wall member is hung from the ledger.

In another aspect, an exemplary embodiment of the present disclosure may provide a method of assembling a debris chute assembly including providing a scaffold and providing a plurality of wall members. The method may include engaging a wall member of the plurality of wall members with a portion of the scaffold. The method may further include providing a flange on the wall member and providing a fastener on the flange. The method may further include engaging a tie wire with the fastener and securing the tie wire and thereby the flange and the wall member to a portion of the scaffold.

In another aspect, an exemplary embodiment of the present disclosure may provide a step of securing the tie wire further that includes threading the tie wire through an eye of the fastener, extending the tie wire around the portion of the scaffold, tightening the tie wire around the portion of the scaffold, and securing the flange and the wall member to the portion of the scaffold via the tie wire In another aspect, an exemplary embodiment of the present disclosure may provide where the step of tightening the tie wire around the standard includes engaging a portion of the flange of the wall member with a portion of an adjacent wall member of the plurality of wall members and frictionally securing the adjacent wall member to the another portion of the scaffold.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a perspective view of a first embodiment of a debris chute assembly according to the disclosure.

FIG. 2 (FIG. 2) is a perspective view of the debris chute assembly of FIG. 1.

FIG. 3 (FIG. 3) is a detailed perspective view of a corner member of the debris chute assembly of FIG. 1.

FIG. 4 (FIG. 4) is an exploded perspective view of a corner member and a standard of the debris chute assembly of FIG. 1.

FIG. 5 (FIG. 5) is a front view of a corner member of an embodiment of the disclosure.

FIG. 6 (FIG. 6) is a rear view of a corner member of an embodiment of the disclosure.

FIG. 7 (FIG. 7) is an exploded perspective view of a corner member and a standard of an embodiment of the disclosure.

FIG. 8 (FIG. 8) is a front view of a corner member of an embodiment of the disclosure.

FIG. 9 (FIG. 9) is a rear view of a corner member of an embodiment of the disclosure.

FIG. 10 (FIG. 10) is an exploded perspective view of a corner member and a standard of an embodiment of the disclosure.

FIG. 11 (FIG. 11) is a front view of a corner member of an embodiment of the disclosure.

FIG. 12 (FIG. 12) is a rear view of a corner member of an embodiment of the disclosure.

FIG. 13 (FIG. 13) is an exploded detail perspective view of an embodiment of the disclosure.

FIG. 14 (FIG. 14) is an in-use view of an embodiment of the disclosure.

FIG. 15 (FIG. 15) is an enlarged partial front, left, top isometric perspective view of a second embodiment of a debris chute assembly in accordance with the present disclosure.

FIG. 16 (FIG. 16) is an enlarged front, left, top isometric perspective view of a second embodiment of a first wall member of the debris chute assembly of FIG. 15 shown in isolation.

FIG. 17 (FIG. 17) is a further enlarged front, left, top perspective view of a highlighted region of FIG. 16, showing a portion of the second embodiment of the first wall member.

FIG. 18 (FIG. 18) is an enlarged front, left, top isometric perspective view of a second embodiment of a second wall member of the debris chute assembly of FIG. 15 shown in isolation.

FIG. 19 (FIG. 19) is an enlarged and partially exploded front, left, top perspective view of the second embodiment of the second wall member shown in FIG. 18.

FIG. 20 (FIG. 20) is an enlarged front, left, top isometric perspective view of a door of the debris chute assembly of FIG. 15 shown in isolation.

FIG. 21 (FIG. 21) is a further enlarged front, left, top perspective view of the highlighted region of FIG. 20.

FIG. 22 (FIG. 22) is an enlarged partial front, left, top isometric perspective operational view of the debris chute assembly as shown in FIG. 15, showing the door and the second embodiment of the second wall member being installed onto the second embodiment of the debris chute assembly.

FIG. 23 (FIG. 23) is a further enlarged front, left, top perspective view of the highlighted region of FIG. 15, showing the engagement of the second embodiment of the second wall member with one of a plurality of standards of the debris chute assembly.

FIG. 24 (FIG. 24) is a cross-section looking in the direction of line 24-24 of FIG. 23.

FIG. 25 (FIG. 25) is an enlarged front, left, top perspective operational view of the debris chute assembly in accordance with the present disclosure shown in use.

FIG. 26 (FIG. 26) is a front, left, top isometric perspective view of a third embodiment of a debris chute assembly in accordance with the present disclosure.

FIG. 27 (FIG. 27) is an enlarged front, left, top isometric perspective view of a third embodiment of a first wall member of the debris chute assembly of FIG. 26 shown in isolation.

FIG. 28 (FIG. 28) is a further enlarged front, left, top perspective view of a highlighted region of FIG. 27, showing a portion of the second embodiment of the first wall member.

FIG. 29 (FIG. 29) is an enlarged front, left, top isometric perspective view of a third embodiment of a second wall member of the debris chute assembly of FIG. 26 shown in isolation.

FIG. 30 (FIG. 30) is an enlarged front, left, top isometric perspective view of a third wall member of the debris chute assembly of FIG. 26 shown in isolation.

FIG. 31 (FIG. 31) is a further enlarged front, left, top isometric perspective view of a highlighted region of FIG. 30, showing a portion of the third wall member.

FIG. 32 (FIG. 32) is a cross-section looking in the direction of line 32-32 of FIG. 26.

FIG. 33 (FIG. 33) is an enlarged top plan view of a highlighted region of FIG. 32 showing how the wall members are secured to the scaffold.

FIG. 34 (FIG. 34) is an enlarged top plan view of a portion of the highlighted region of FIG. 32, showing an alternative variant of how the wall members are secured to the scaffold.

FIG. 35 (FIG. 35) is an enlarged front, left, top perspective view of a fourth embodiment of a debris chute assembly in accordance with the present disclosure.

FIG. 36 (FIG. 36) is an enlarged front, left, top isometric perspective view of a fifth embodiment of a second wall member of the debris chute assembly of FIG. 35 shown in isolation.

### DETAILED DESCRIPTION

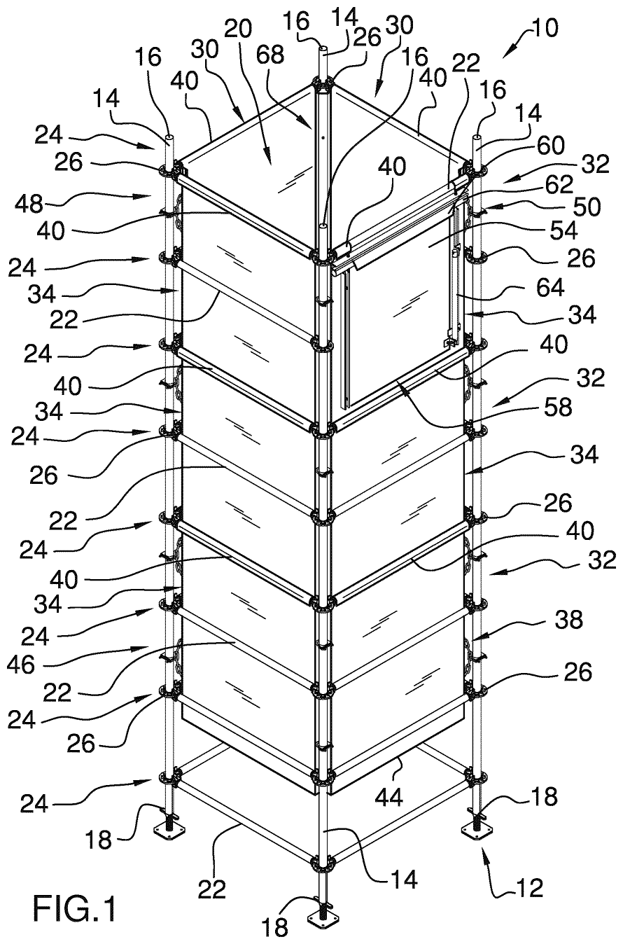

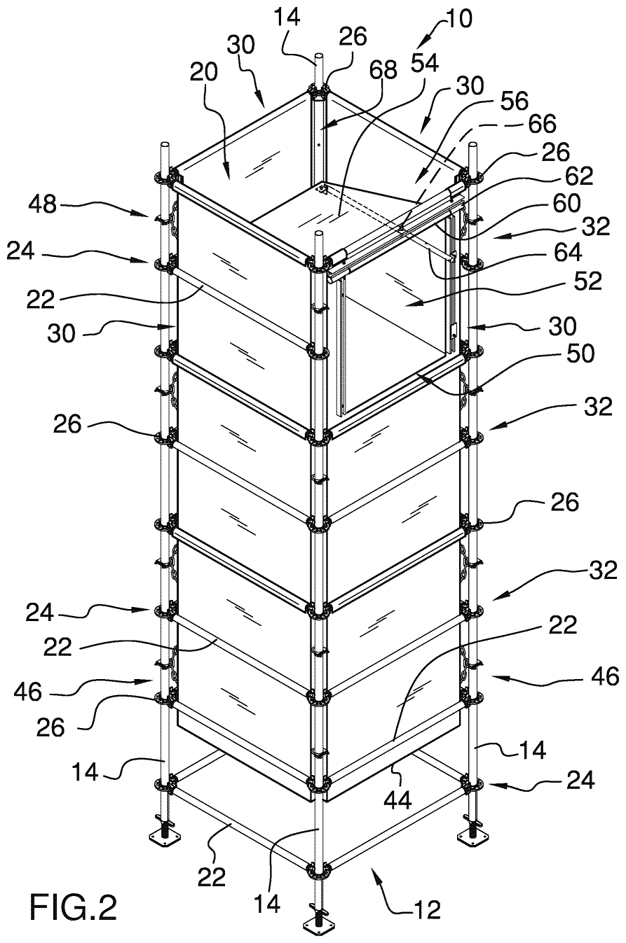

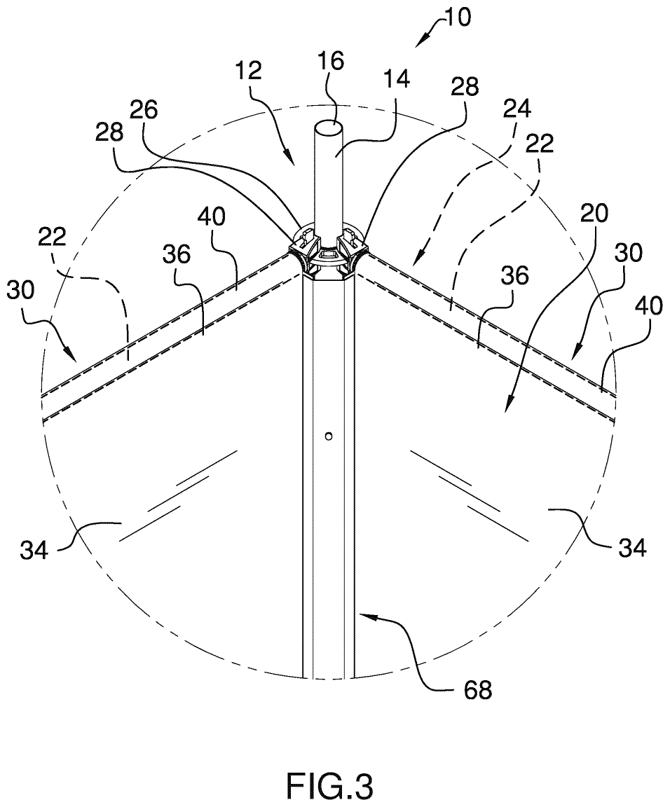

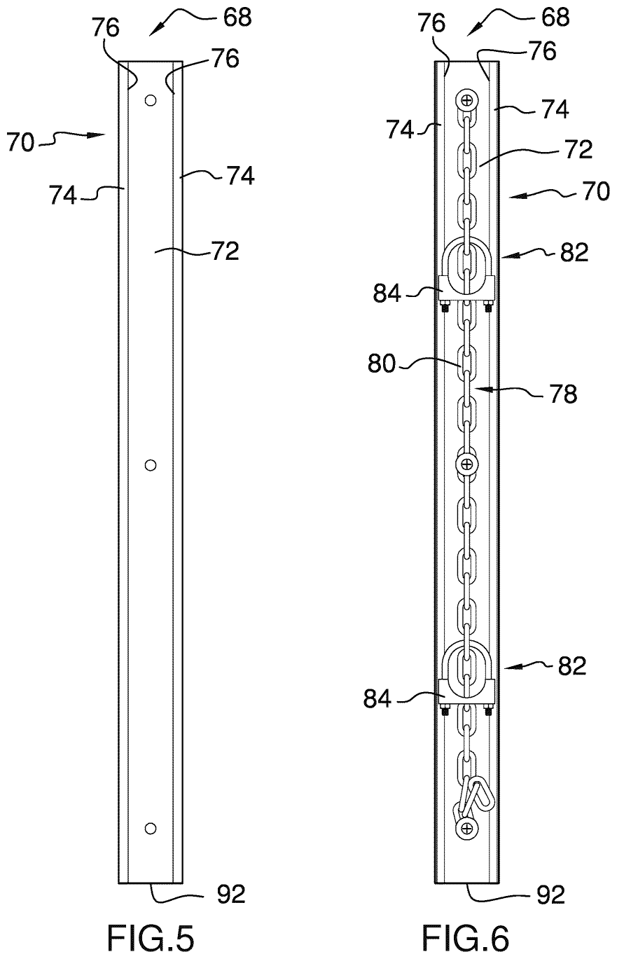

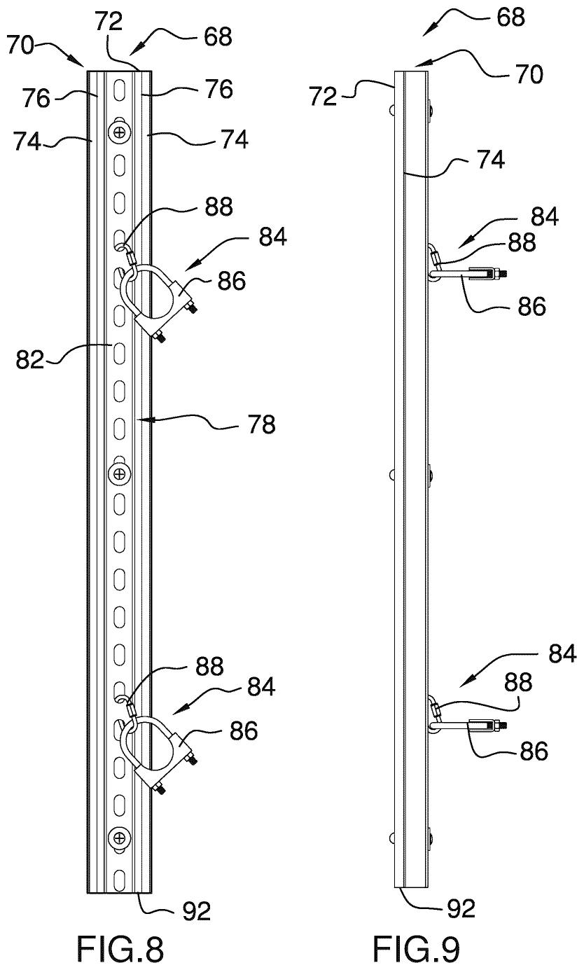

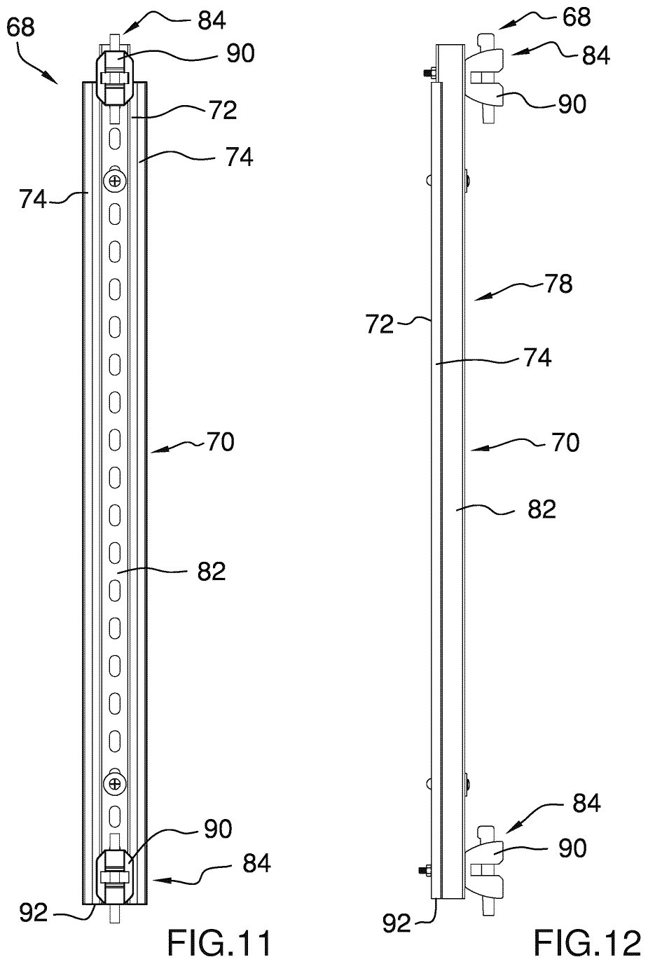

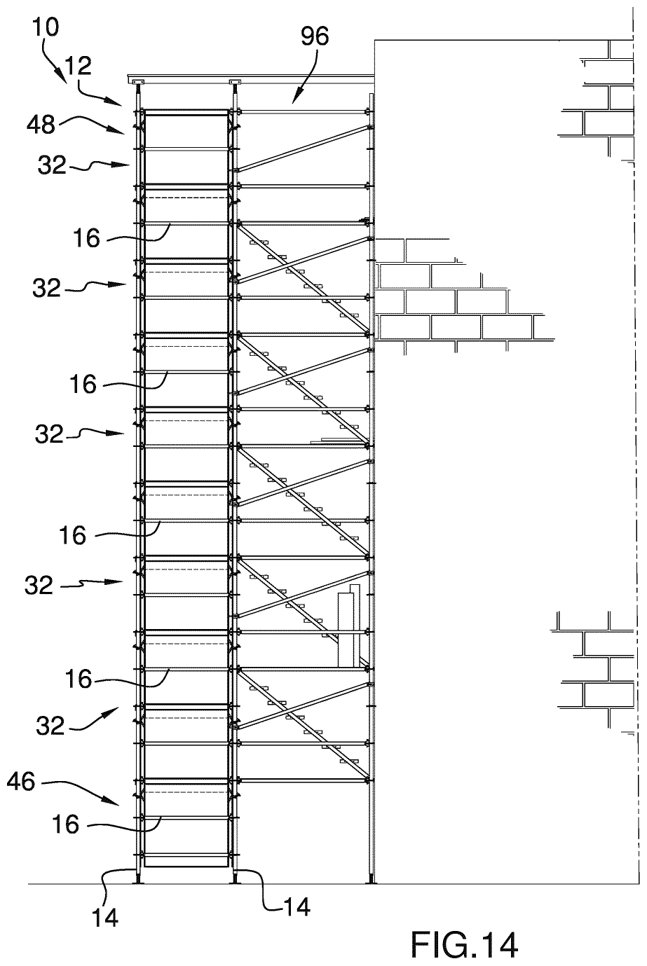

With reference now to the drawings, and in particular to FIGS. 1 through 14 thereof, a new debris chute embodying the principles and concepts of an embodiment of the disclosure and generally designated by the reference numeral 10 will be described.

As best illustrated in FIGS. 1 through 14, the debris chute assembly 10 generally comprises a scaffold 12 having a plurality of standards 14 and a plurality of ledgers 22. The standards 14 are spaced from each other and extend between a top end 16 and a bottom end 18. The standards 14 define a channel 20 between the standards 14. Each ledger 22 is coupled to and extends between a pair of associated standards 14 of the plurality of standards 14. The ledgers 22 are arranged in a plurality of levels 24 which are spaced from each other along the channel 20. In each level 24, the ledgers 22 form a closed loop around the channel 20.

The scaffold 12 also includes a plurality of rosettes 26 and a plurality of wedge pins 28. Each rosette 26 is coupled to an associated standard 14 of the plurality of standards 14, and each wedge pin 28 extends through an associated ledger 22 of the plurality of ledgers 22 and an associated rosette 26 of the plurality of rosettes 26, thereby securing the associated ledger 22 to the associated rosette 26. It is contemplated that other embodiments may not have the scaffold 12 but may instead use vertical and horizontal members similar to the standards 14 and ledgers 22 of the scaffold 12. It is noted, however, that a particular advantage of including the scaffold 12 is that the scaffold 12 may be easily attached to further scaffolding 96 built for workers to navigate to perform various construction and repair activities and to access the debris chute assembly 10. The scaffold 12 of some embodiments may not have rosettes 26 and wedge pins 28, instead relying on alternative attachment means known to the art such as clamps.

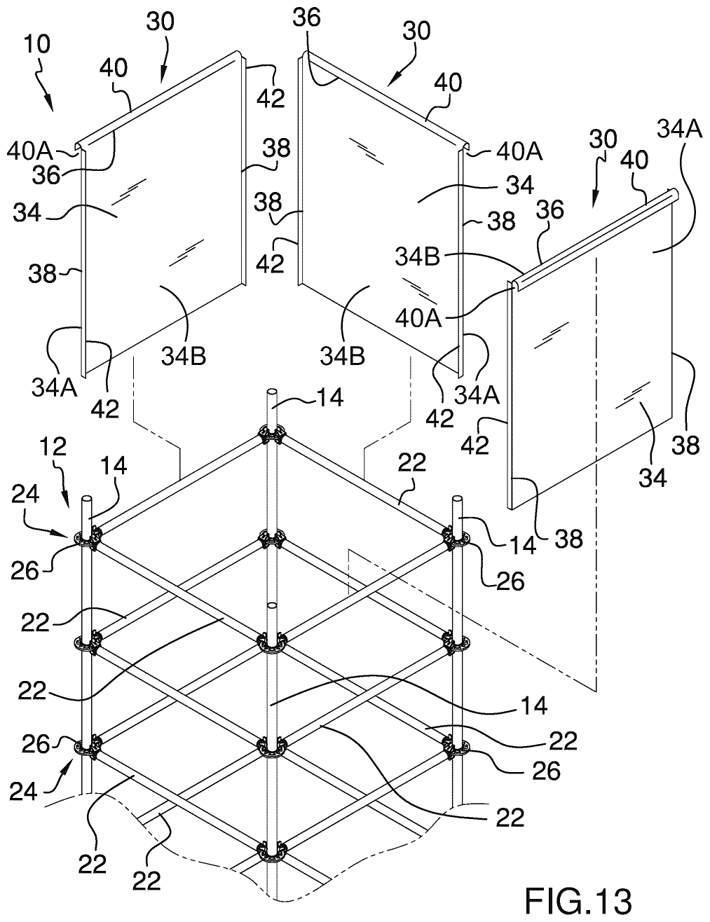

A plurality of wall members 30 is removably coupled to the scaffold 12. The wall members 30 are arranged in a plurality of tubular sections 32 which surround the channel 20. Each tubular section 32 is coupled to the ledgers 22 of an associated level 24 of the plurality of levels 24. Each wall member 30 of the plurality of wall members 30 comprises a wall panel 34, a hook 40, and a pair of wall flanges 42. As best seen in FIG. 13, Each wall panel 34 has an outer surface 34A, an inner surface 34B, an upper end 36, a lower end 37, and a pair of lateral edges 38 extending between the upper end 36 and lower end 37. The inner surfaces 34B of the wall panels 34 bound and define the channel 20 extending through debris chute assembly 10. The hook 40 is coupled to an upper end 36 of the wall panel 34 and a passageway 40A is defined between the hook 40 and outer surface 34A. Hook 40 is configured to receive an associated ledger 22 of the ledgers 22 and to enable the wall panel 34 to hang from the associated ledger 22 of the ledgers 22 of the associated level 24. The hook 40 extends outwardly from the channel 20 and from the wall panel 34. The pair of wall flanges 42 is coupled to a pair of lateral edges 38 of the wall panel 34. The wall flanges 42 extend inwardly into the channel 20 from the wall panel 34, and each wall flange 42 of the pair of wall flanges 42 is oriented perpendicularly to the wall panel 34. The wall panel 34, hook 40, and wall flanges 42 are formed of a unitary sheet metal but may use other suitable materials. A lower end 44 of each tubular section 32 except a bottommost section 46 of the plurality of tubular sections 32 overlaps an upper end 36 of an associated adjacent tubular section 32 of the plurality of tubular sections 32, closing any gaps that would otherwise form between tubular sections 32.

One of the wall members 30 of a topmost section 48 of the plurality of tubular sections 32 defines a hopper wall member 50, and other embodiments may include more hopper wall members 50. The wall panel 34 of the hopper wall member 50 defines an aperture 52 which extends through the wall panel 34. The hopper wall member 50 further comprises a door 54 to access the channel 20 through the aperture 52, a bar 62, and a prop 64. The door 54 is pivotally coupled to the wall panel 34 of the hopper wall member 50 and is movable between an open position 56 and a closed position 58 with respect to the aperture 52. The door 54 has a hooked upper edge 60 which extends around the bar 62, which is coupled to the wall panel 34. The bar 62 is oriented horizontally so that the door 54 is pivotable around the bar 62 and gravity biases the door 54 toward the closed position 58.

The prop 64 is engageable with the door 54 to maintain the door 54 in the open position 56. The prop 64 is telescopically extendable and is mounted to the door 54 and the wall panel 34 of the hopper wall member 50. The prop 64 is lockable in an extended position to maintain the door 54 away from the wall panel 34 in the open position 56. A locking pin 66 or similar may be employed to lock the prop 64 in the extended position. It may be possible to secure the prop 64 in multiple positions such that the door 54 may be adjusted to various degrees of openness with respect to the aperture 52.

A plurality of corner members 68 is removably coupled to the scaffold 12. Each corner member 68 is releasably mounted to an associated standard 14 of the plurality of standards 14 and is positioned between a pair of associated wall members 30 of the plurality of wall members 30. The corner members 68 act to close gaps made between wall members 30 of the same tubular section 32 and keep the wall members 30 from swinging inwardly into the channel 20 due to wind or other external forces.

Each corner member 68 comprises a corner panel 70, an elongated member 78, and a plurality of couplers 84. The corner panel 70 engages the pair of associated wall members 30 to retain the panels of the pair of associated wall members 30 in a fixed position with respect to the scaffold 12. The corner panel 70 comprises a central portion 72 and a pair of flange portions 74. The pair of flange portions 74 is coupled to a pair of side edges 76 of the central portion 72, and each flange portion 74 engages the wall flange 42 of one of the pair of associated wall members 30. The flange portions 74 may form 45-degree angles with the central portion 72 to align with the wall flanges 42 of the associated wall members 30. The corner panel 70 comprises a unitary sheet metal but may use other suitable materials.

The elongated member 78 is coupled to the corner panel 70 and is oriented parallel to the associated standard 14. The plurality of couplers 84 is coupled to the elongated member 78 and the associated standard 14, thereby securing the corner member 68 to the standard 14. A downward end 92 of each corner member 68 except a bottommost corner member (not shown) overlaps an upward end of an associated adjacent corner member 68 of the plurality of corner members 68, covering any gaps that would otherwise be formed between adjacent corner members 68.

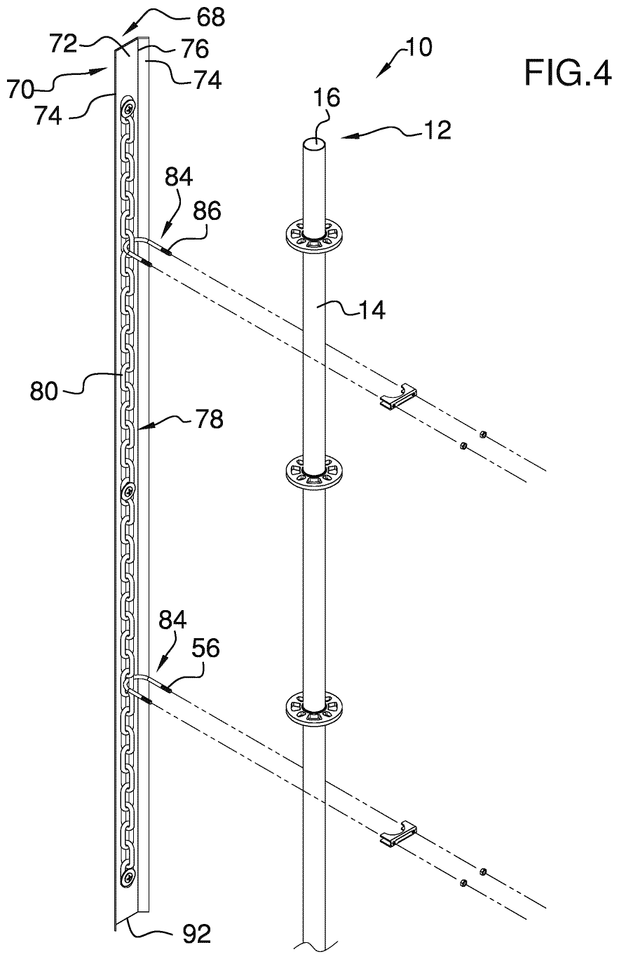

Various embodiments of the corner members 68 are depicted in the figures. In reference to FIGS. 4 through 6, a first embodiment of the corner members 68 is depicted, in which the elongated member 78 comprises a chain 80, and each coupler 84 of the plurality of couplers 84 comprises a U-bolt clamp 86. Each coupler 84 is interlocked with the chain 80 and clamps onto the associated standard 14. Couplers 84 of similar embodiments may include pipe clamps, ties, latches, or the like.

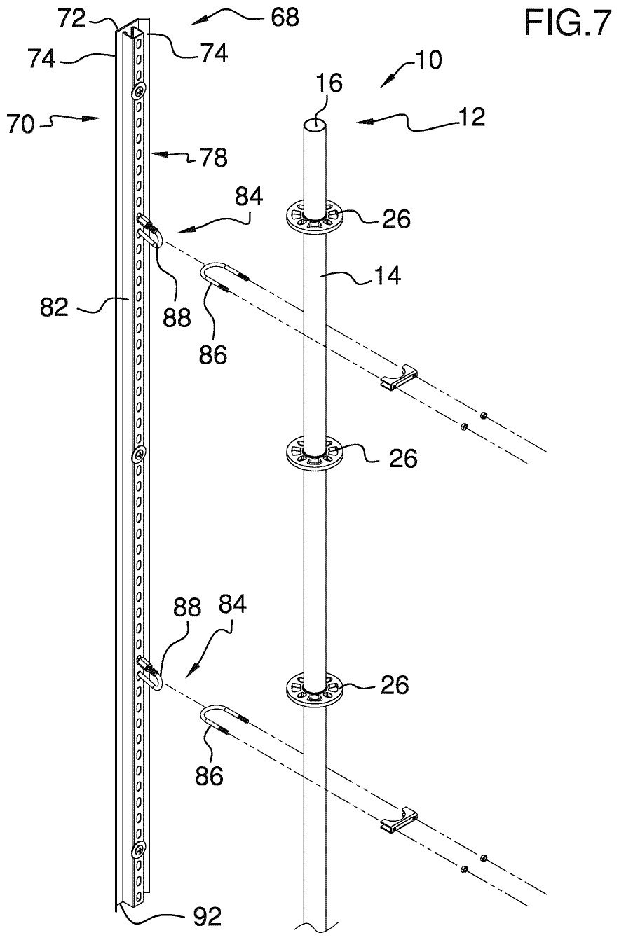

FIGS. 7 through 9 show a second embodiment of the corner members 68, in which the elongated member 78 comprises a slotted channel 82, and each coupler 84 comprises a quick-chain link 88 and a U-bolt clamp 86. The quick-chain link 88 of each coupler 84 is interlocked with the slotted channel 82. The U-bolt interlocks with the quick-chain link 88 and clamps onto the associated standard 14. Couplers 84 of similar embodiments may include pipe clamps, ties, latches, or the like.

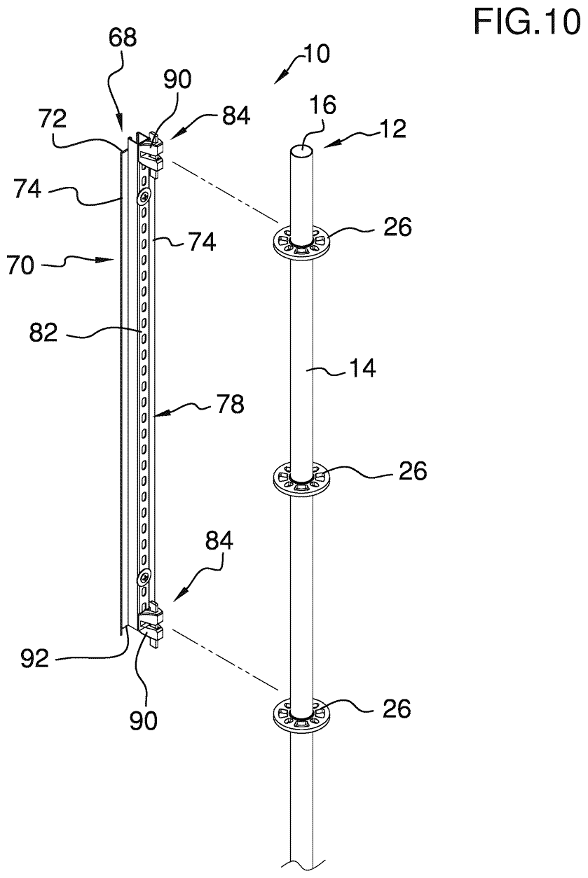

In reference to FIGS. 10 through 12, a third embodiment of the corner members 68 is depicted in which the elongated member 78 comprises a slotted channel 82 and each coupler 84 of the plurality of couplers 84 comprises a wedge pin coupling 90. Each coupler 84 of the plurality of couplers 84 is coupled to an associated rosette 26 on the associated standard 14.

In use, the debris chute assembly 10 is assembled as described and debris from construction work or the like is fed through apertures 52 of hopper wall members 50 to be dropped into a desired location below the debris chute assembly 10. A dumpster or similar may be positioned below the debris chute assembly 10 to contain the dropped debris.

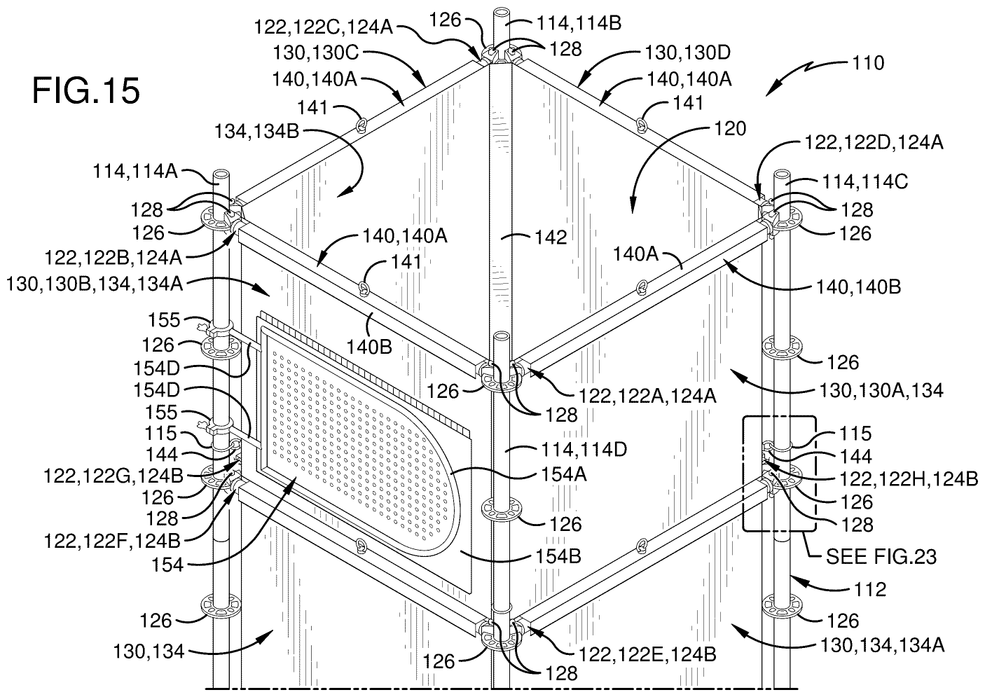

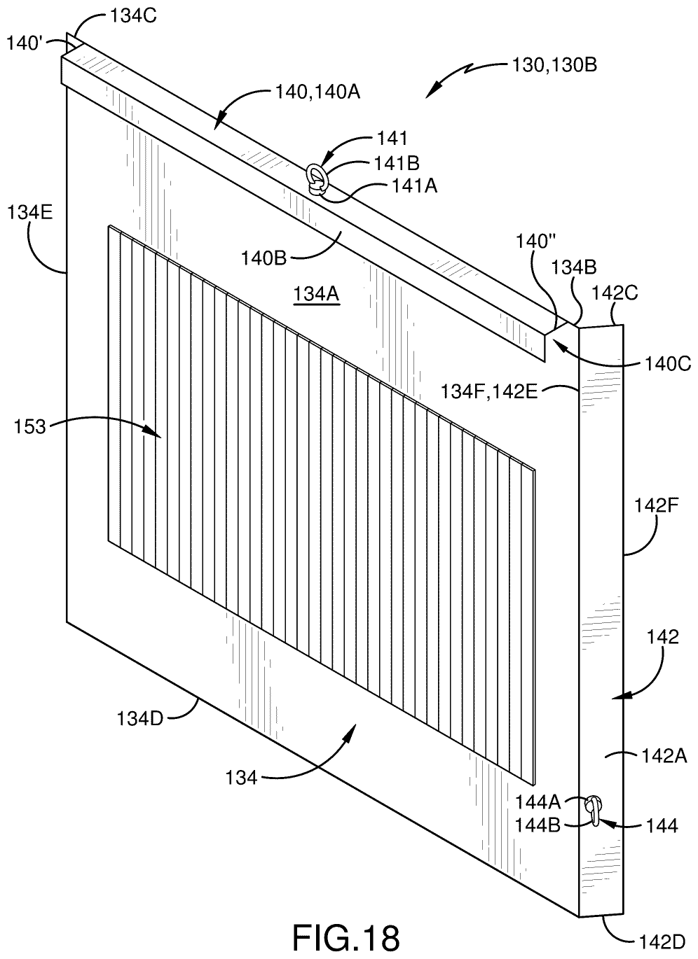

Referring now to FIGS. 15-25, there is shown a second embodiment of a debris chute assembly in accordance with the present disclosure, with the debris chute assembly being generally indicated at 110. The debris chute assembly 110 includes a scaffold 112 and a plurality of wall members 130 which are engaged with the scaffold 112. The scaffold 112 is substantially identical in structure and function to scaffold 12 and will therefore not be described in much further detail herein. Scaffold 112 includes a plurality of standards 114 and a plurality of ledgers 122, which are substantially identical in structure and function to the plurality of standards 14 and the plurality of ledgers 22 of scaffold 12, respectively. In particular, the standards 114 are laterally and longitudinally spaced from one another and extend vertically between a top end and a bottom end of the scaffold 112. Each ledger 122 is coupled to and extends horizontally between a pair of adjacent standards 114 of the plurality of standards 114. The ledgers 122 are spaced a vertical distance from one another along the standards 114 and are thereby arranged in a plurality of levels similar to the levels 24 of the debris chute assembly 10. The wall members 130 engage the ledgers 122 and standards 114 to form the debris chute assembly 110, as will be described in greater detail hereafter. A channel 120 is bounded and defined by the wall members 130 and the channel 120 extends from proximate the top end of the scaffold 112 to proximate a bottom end of the scaffold 112.

Referring now to FIG. 15, debris chute assembly 110 includes a first standard 114A, a second standard 114B, a third standard 114C, and a fourth standard 114D which are oriented laterally and longitudinally relative to one another so as to form a generally square shape when debris chute assembly 110 is viewed from above. The standards 114A, 114B, 114C, 114D are arranged substantially parallel to one another and are vertically oriented when debris chute assembly 110 has been constructed.

Each one of the plurality of ledgers 122 extends between at least two of the first standard 114A, second standard 114B, third standard 114C or fourth standard 114D. In particular, each ledger 122 extends between two adjacent standards 114 such that at any horizontal level of standards in scaffold 112, there are four ledgers which are arranged in opposed pairs. Referring to FIG. 15, the plurality of ledgers 122 includes a first set of ledgers 122A, 122B, 122C, 122D which together comprise a first level 124A of ledgers, and a second set of ledgers 122E, 122F, 122G, 122H which comprise a second level 124B of ledgers. It will be understood that the debris chute assembly 110 includes any number of sets of ledgers which are arranged in any number of levels as dictated by the use of debris chute assembly 110.

Debris chute assembly 110 further includes a plurality of wall members 130 which are engaged with scaffold 112. As shown in FIG. 15, four wall members 130A, 130B, 130C, and 130D are engaged with the first set ledgers 122A, 122B, 122C, 122D, respectively, of the first level 124A of ledgers 122 in the scaffold 112. Each one of the plurality of wall members 130 is engaged with one of the ledgers 122 which extends between an adjacent two of the first standard 114A, second standard 114B, third standard 114C and fourth standard 114D. It will be understood that wall members are not engaged with every level of ledgers in debris chute assembly 110. FIG. 1 shows that every alternating level of ledgers 122 is free of any engagement with any wall members FIG. 15 shows that every level of ledgers 122 is engaged with four wall members 130. The engagement of wall members 130 with each level of ledgers 122 will be determined by the situation in which the debris chute assembly 110 is to be used.

Referring now to FIG. 15, the plurality of wall members 130 which removably engages the scaffold 112 includes a plurality of first wall members 130A, 130C, 130D and at least one second wall member 130B. The first wall members 130A, 130C, 130D are of substantially identical configuration and the at least one second wall member 130B is of a different configuration from the first wall members. The at least one second wall member 130B is also referred to herein as a hopper wall member.

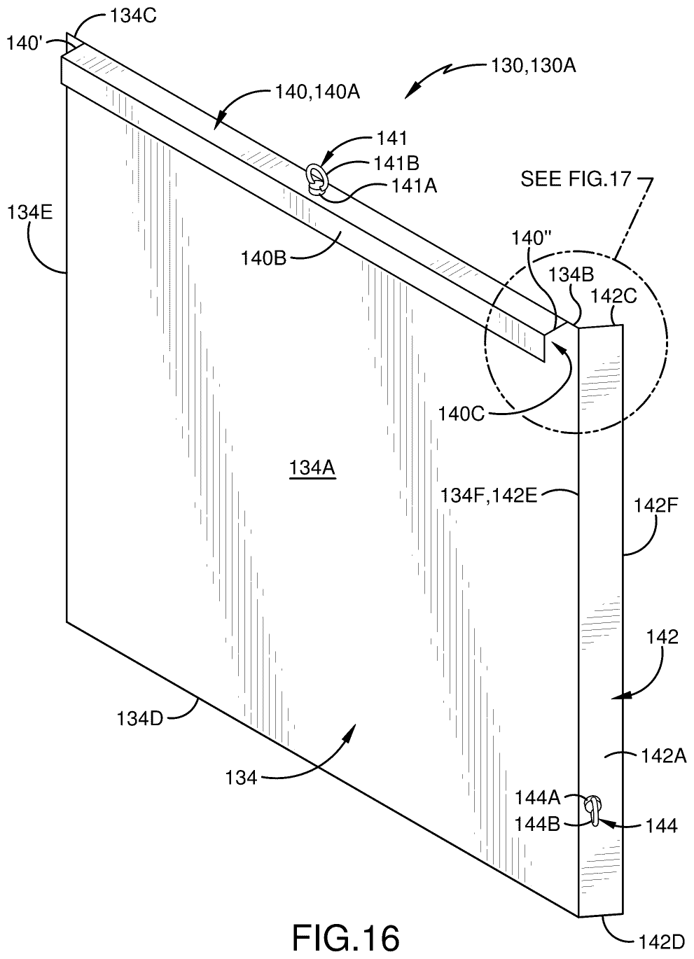

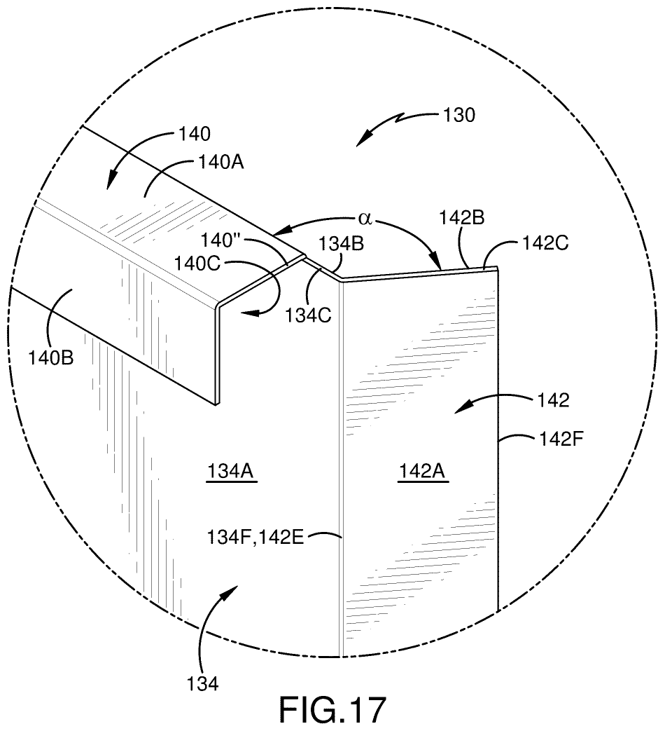

Referring now to FIGS. 16 and 17, the first wall member 130A is shown in greater detail. (It will be understood that first wall members 130C, 130D are substantially identical in structure and function to first wall member 130A and the description of first wall member 130A applies equally to wall members 130C, 130D.)

First wall member 130A includes a wall panel 134, a hook or connector 140, and a wall flange 142. The wall panel 134 has an outer surface 134A and an inner surface 134B located opposite one another. The wall panel 134 also includes a top 134C and a bottom 134D located opposite one another, and a first side 134E and a second side 134E located opposite one another.

The connector 140 is integral with or coupled to wall panel 134 proximate the top 134C of wall panel 134. The connector 140 extends outwardly from the outer surface 134A of the wall panel 134. The connector 140 includes a first leg 140A and a second leg 140B. The first leg 140A extends outwardly from the outer surface 134A at the top 134C of the wall panel 134. In one embodiment, the first leg 140A is oriented perpendicular to the outer surface 134A. The second leg 140B extends downwardly from the end of first leg 140A, such that the first leg 140A and the second leg 140B are arranged generally to form an L-shape. In one embodiment, the second leg 140B is oriented substantially perpendicular to the first leg 140A. An inner surface (not numbered) of the first leg 140A, the inner surface (not numbered) of the second leg 140B, and the outer surface 134A of the wall panel 134 together define a passageway 140C. The passageway 140C is configured to receive one of the plurality of ledgers 122 therein when the wall member 130 is to be engaged with the ledger 122. In one embodiment, the dimensions of the passageway 140C are complementary to the dimensions of the ledger 122 to be received therein. Connector 140 has an overall length measured from a first side 140′ to a second side 140″ thereof. The first side 140′ is proximate the first side 134E of the wall panel 134. The second side 140″ is proximate the second side 134F of the wall panel 134. In one embodiment, the overall length of connector 140 is in the range of about 31 inches up to about 67 inches.

In accordance with an aspect of the present disclosure, at least one attachment member 141 extends outwardly from an outer surface (not numbered) of the first leg 140A of the connector 140. In one specific embodiment, at least one attachment member 141 is an eyebolt. The at least one attachment member 141 includes a shaft 141A and an eye 141B operably engaged with the shaft 141A. The shaft 141A is orthogonal to an outer surface (not numbered) of the connector 140. Specifically, shaft 141A is orthogonal to the outer surface (not numbered) of the first leg 140A of the connector 140. Shaft 141A is parallel to the outer surface 134A of the wall panel 134. In one embodiment, a single attachment member 141 is located approximately midway between the first side 140′ and the second side 140″ of the connector 140. It will be understood, however, that the attachment member 141 may be provided at any desired location on connector 140 and that more than a single attachment member 141 may be provided on connector 140 at any suitable or desired locations. The purpose of attachment member 141 will be discussed later herein.

Referring still to FIGS. 16 and 17, the wall flange 142 provided on wall panel 134 is integral with or coupled to one of the first side 134E and the second side 134F of the wall panel 134. As illustrated in FIG. 16, wall flange 142 extends outwardly from the second side 134F of the wall panel 134. Wall flange 142 includes a first surface 142A and a second surface 142B opposite one another. Wall flange 142 further includes a top 142C and a bottom 142D opposite one another. Wall flange 142 further includes a first side 142E and a second side 142F opposite one another. The first surface 142A and second surface 142B of the wall flange 142 are substantially continuous with the outer surface 134A and the inner surface 134B of the wall panel 134, respectively. The top 142C and the bottom 142D of the wall flange 142 are substantially aligned with the top 134C and bottom 134D of the wall panel 134, respectively. First side 142E of wall flange 142 is continuous with second side 134F of wall panel 134 and second side 142F of wall flange 142 is spaced a distance away from second side 134F of wall panel 134. It will be understood that in other embodiments, top 142C and/or bottom 142D of wall flange 142 may be recessed a distance inwardly from top 134C and/or bottom 134D of wall panel 134, respectively. Additionally, it should be understood that wall flange 142 may comprise a plurality of smaller wall flanges that are spaced vertically from one another along second side 134F of wall panel 134 (or along first side 134E of wall panel 134).

It will be understood that if wall flange 142 extends outwardly from first side 134E of wall panel 134, then second side 134F of wall panel 134 will be free of wall flange 142. Similarly, it will be understood that is wall flange 142 extends outwardly from second side 134F of wall panel 134, then first side 134E if free of wall flange 124.

It should be noted that in other embodiments, a wall flange may extend outwardly from each of the first side 134E and second side 134F of wall panel 134.

As best seen in FIG. 17, wall flange 142 is arranged at an angle “α” relative to the wall panel 134, where the angle “α” is measured between the second surface 142B of the wall flange 142 and the inner surface 134B of the wall panel 134.

In one embodiment, the angle “α” is greater than 90 degrees. In one embodiment, angle “α” is between 95-155 degrees. More specifically, angle “α” is between 110-140 degrees. Most specifically, angle “α” is about 125 degrees.

In accordance with an aspect of the present disclosure, at least one fastener 144 extends outwardly from the wall flange 142. In one specific embodiment, at least one fastener 144 is an eyebolt. The at least one fastener 144 includes a shaft 144A and an eye 144B operably engaged with the shaft 144B. The shaft 144A is orthogonal to the first surface 142A of the wall flange 142. In one embodiment, the at least one fastener 144 extends outwardly from the first surface 142A of the wall flange 142. As illustrated in FIG. 16, a single fastener 144 extends outwardly from the first surface 142A of wall flange 142 at a location closer to the bottom 142D of the wall flange 142 than to the top 142C thereof. It will be understood that in other embodiments, the fastener 144 may be provided at any desired location along the wall flange 142. In yet other embodiments, more than a single fastener 144 may extend outwardly from wall flange at any desired locations. The purpose of fastener 144 will be discussed later herein.

The wall member 130 has an overall length (not numbered) measured from a first side 134E of wall panel 134 to a second side 142F of wall flange 142. In one specific embodiment, the overall length of the wall member 130 may be in the range of about 32 inches to about 66 inches. The wall member 130 has an overall height (not numbered) measured from the top 134C of wall panel 134 to the bottom 134D of wall panel 134. In one specific embodiment, the overall height of the wall member 130 may be about 44 inches.

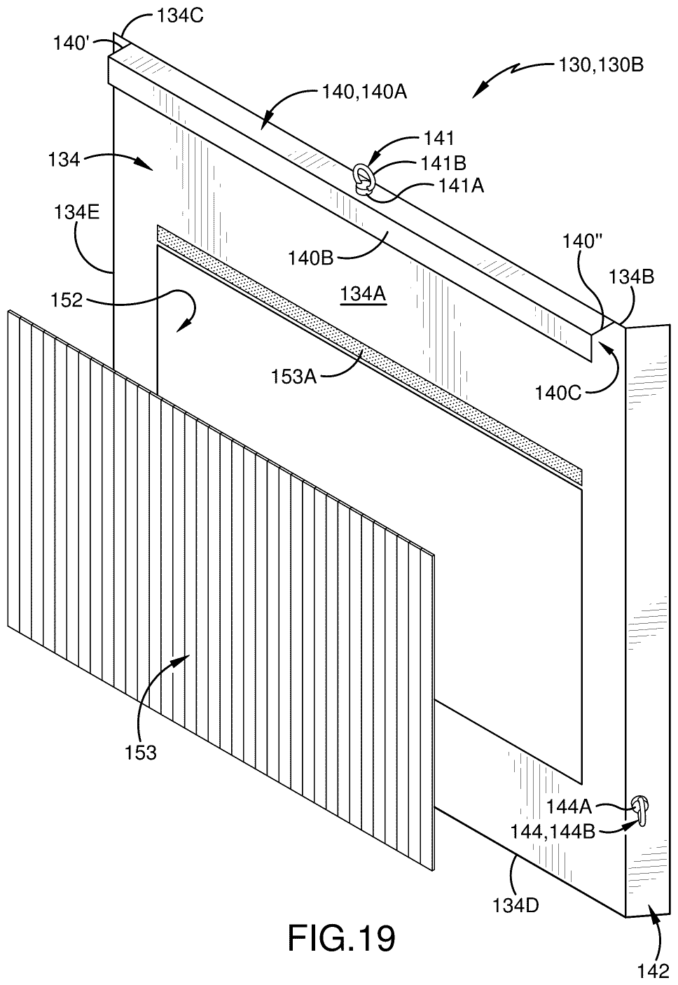

Referring now to FIGS. 15 and 18-21, the at least one second wall member 130B utilized in debris chute assembly 110 is identical to first wall member 130A except for the specific features discussed hereafter. Unlike the first wall member 130A, the at least one second wall member 130B defines an aperture 152 (FIG. 19) in the wall panel 134. The aperture 152 extends from outer surface 134A to inner surface 134B of wall panel. The aperture 152 is spaced a distance inwardly from each of the top 134C, bottom 134D, first side 134E, and second side 134F of wall panel 134. When the at least one second wall member 130B is engaged on scaffold 112, the aperture 152 is placed in fluid communication with the channel 120 defined in debris chute assembly 110.

The second wall member 130B further includes a sheet 153 secured to the wall panel 134 by a securement mechanism 153A. The sheet 153 is located so as to cover the aperture 152. The sheet 153 selectively allows access to the aperture 152, as will be discussed more fully later herein. In one embodiment, the sheet 153 is comprised of a flexible material. The flexible material may be a rubber sheet with slits cut therethrough to allow for access to the channel 120 of the debris chute assembly 110. Sheet 153 allows a user to insert debris into the channel 120 in the chute 110 but simultaneously aids in preventing debris within the channel 120 or dust from that debris from escaping from the channel 120 of the debris chute assembly 110.

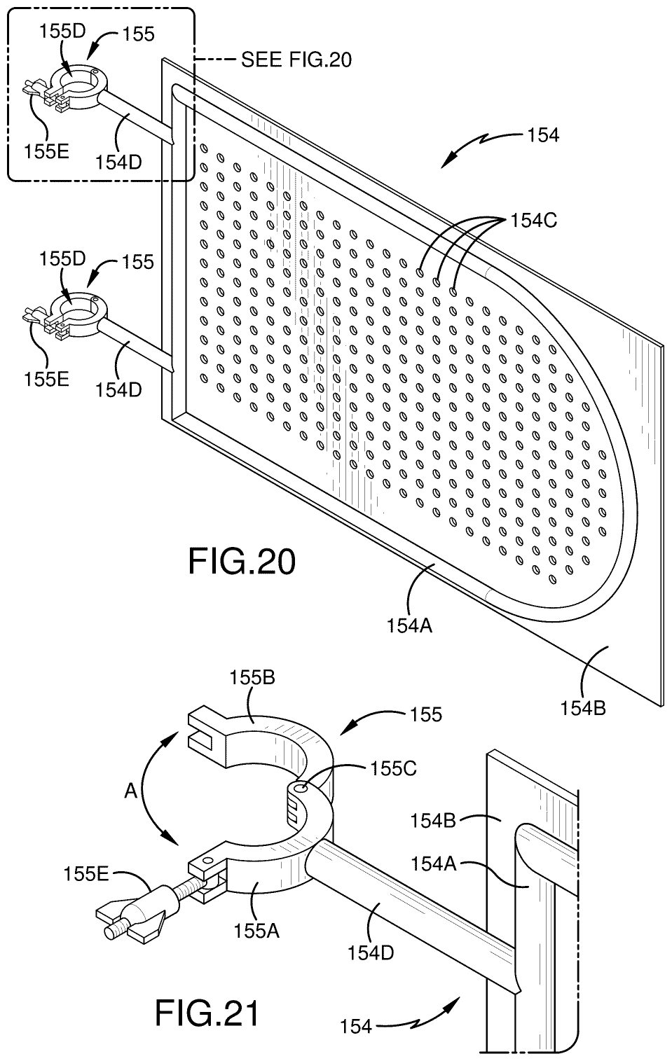

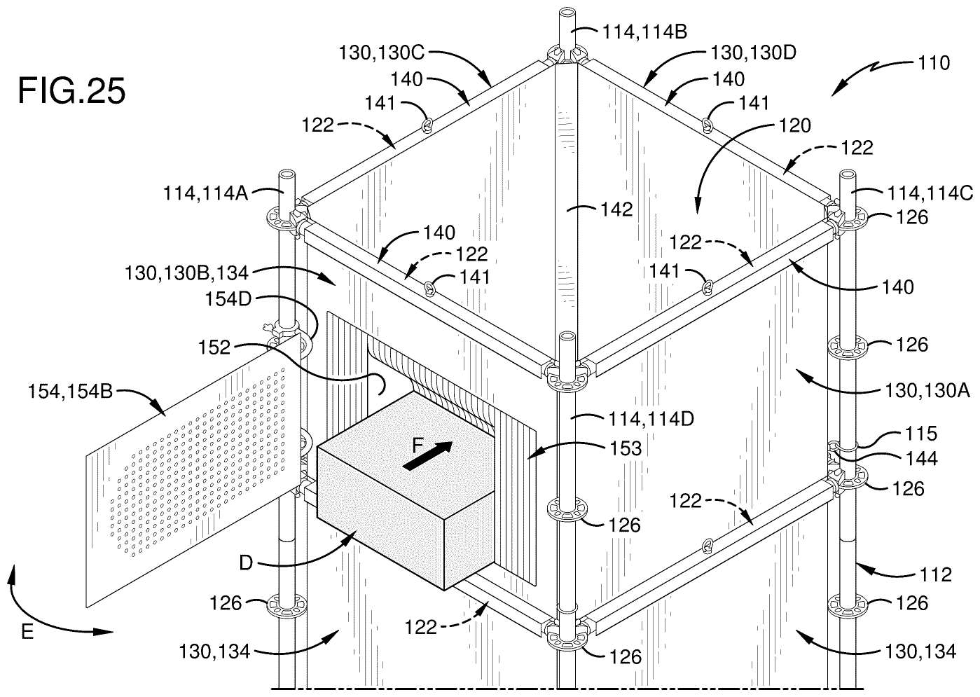

Referring now to FIGS. 20 and 21, the debris chute assembly 110 further includes a door 154 which is located so as to selectively restrict access to the aperture 152 defined in at least one second wall member 130B. The door 154 is pivotable between a closed position (FIG. 15) and an open position (FIG. 25). When in the open position (FIG. 25), a user is allowed access to the channel 120 (FIG. 15) of the debris chute assembly 110 through the aperture 152. The door 154 is biased to the closed position or is self-closing to block access to the aperture 152 and to prevent the door 154 from being accidentally left open.

Referring to FIGS. 20 and 21, the door 154 includes a frame 154A and a panel 154B. The frame 154A provides strength to the door 154. The panel 154B engages with the frame 154A and is configured to cover and inhibit access to the aperture 152 and sheet 152 when the door 154 is in the closed position.

As illustrated in FIG. 20, panel 154B defines a plurality of holes 154C extending through the panel 154B. It will be understood that panel 154B may alternatively have any size or shape holes, cavities, depressions, cutouts, wells, apertures, or pockets extending therethrough or extending partially therethrough. It will also be understood that panel 154B may alternatively be substantially continuous and free of any holes 154C.

The door panel 154B has an overall length measured from a first side (not numbered) to a second side (not numbered) of the panel. In one embodiment, the overall length of the panel 154B may be from about 38 inches up to about 63 inches. The door panel 154B has an overall height measured from the top (not numbered) to a bottom (not numbered) of the panel 154B. In one specific embodiment, the overall height of the panel 154E may be about 23 inches.

Referring to FIGS. 20 and 21, the door 154 further includes at least one shaft 154D extending outwardly from the frame 154A. In one specific embodiment, the at least one shaft 154D may include a spring or another component that will bias the door 154 to the closed position. Then the door 154 is in the closed position, access to the channel 120 of the debris chute assembly 110 is restricted. It will also be understood that the at least one shaft 154D may be covered in an outer material which prevents debris from interfering with the operation of the door 154 and prevents the door 154 from being biased to the closed position.

The door 154 further includes at least one securement mechanism 155 which is provided on the door 154 to selectively secure the door 154 to one of the plurality of standards 114 (FIG. 15) located in the general vicinity of the aperture 152 defined in the second wall member 130B. The securement mechanism 155 comprises a base 155A and a cuff 155B. The base 155A extends outwardly from a free end of the at least one shaft 154E. In one specific embodiment, the cuff 155A is a u-shaped member. Cuff 155B engages the base 155A via a hinge 155C. The cuff 155B is moveable relative to the base 155A via the hinge 155C and is movable between an open position and a closed position as indicated by arrow “A” in FIG. 21. When cuff 155B is in the closed position, an aperture 155D (FIG. 20) is defined between an interior surface of the base 155A and an interior surface of the cuff 155B. The aperture is of shape and size substantially complementary to a cross section of the standard 114 of the scaffold 112. When the cuff 155B is moved to the open position, one of the plurality of standards 114 is partially receivable into the aperture defined between base 155A and cuff 155B. When one the plurality of standards 114 is partially received within the aperture, the cuff 155B is then rotated to the closed position via the hinge 155C and the one of the plurality of standards 114 is thereby captured between the base 155A and the cuff 155B. When the cuff 155B is in the closed position a locking mechanism 155E provided on the securement mechanism 155 is activated and locks the base and the cuff to one another and thereby secures the securement mechanism 155 to the standard 114. In one specific embodiment, the screw is a wing bolt or a finger screw. The wing bolt or finger screw is finger tightenable. In other words, the securement mechanism 155 can be engaged with the scaffold 112 without the use of manufactured tools such as a wrench or screwdriver. The locking mechanism 155E is rotatable in a first direction to lock the cuff 155C to the base 155A and is rotatable in a second direction to release cuff 155C from base 155A.

It will be understood that in alternative embodiments, the locking mechanism 155E may be activated and deactivated with the use of manufactured tools, such as a wrench or screwdriver.

Referring to FIG. 15, it will be noted that when debris chute assembly 110 is assembled, the inner surfaces of the wall panels 134 and the flanges 142 of the plurality of wall members 130 together bound and define the channel 120 of the debris chute assembly 110.

Having now described the structure of the debris chute assembly 110, a method of assembling and utilizing debris chute assembly 110 will now be described.

Although not specifically illustrated herein, it will be understood that the scaffold 112 is assembled by placing a plurality of rosettes 126 at desired intervals along the length of each of the plurality of standards 114. The rosettes 26 are placed at the same intervals on each standard 114 of the plurality of standards 114 such that when the standards 114 are moved to the vertical position (similar to that shown in FIG. 13), groupings of four rosettes 26 will be horizontally aligned with one another across the four standards 114. The method of assembly of the scaffold 112 further includes positioning the plurality of standards 114 a distance longitudinally and laterally from one another and then sequentially securing the plurality of ledgers 122 between adjacent standards 114. As discussed with respect to the first embodiment debris chute assembly 10, each ledger 122 includes wedge blocks affixed at a first and second end of the ledgers 122. Each ledger 122 includes wedge pins 128 extending outwardly from the ledgers 122 at the wedge blocks and are engaged with associated rosettes 126 until the skeleton of the scaffold 112 is formed. Scaffold 112 will resemble the scaffold 12 shown in FIG. 13 when assembled.

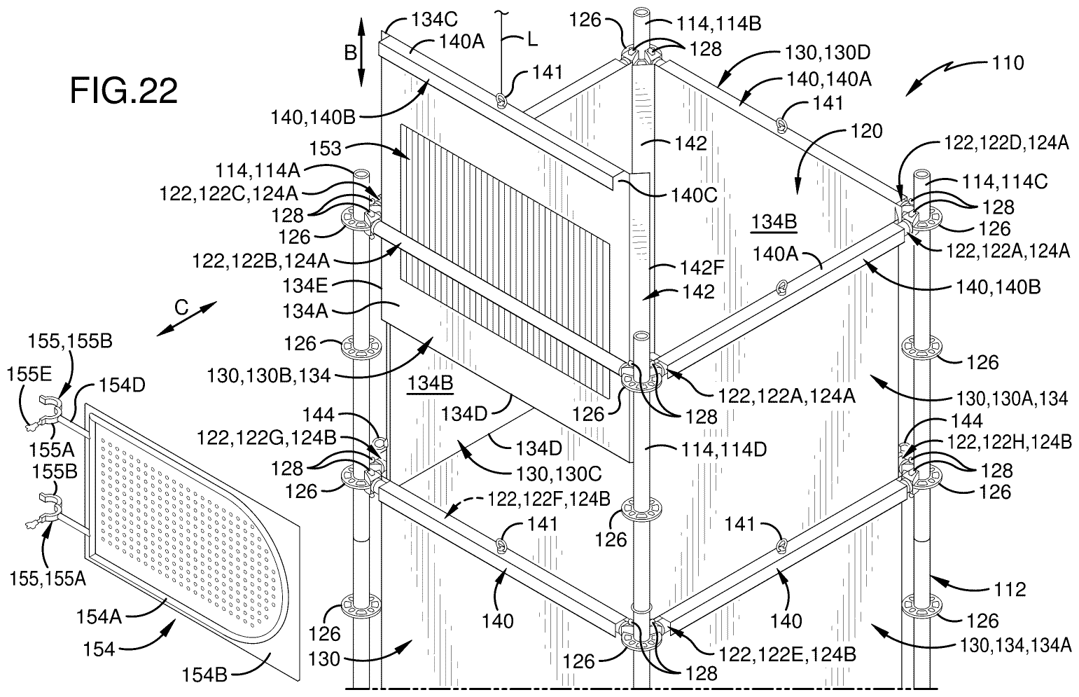

Referring now to FIG. 22, once the plurality of standards 114 and the plurality of ledgers 122 are assembled into the scaffold 112, each wall member 130 of the plurality of wall members 130 is individually moved into engagement with a portion of the scaffold 112. In order to engage an individual wall member 130, a free end of a line “L” (or wire) is engaged with the attachment member 141 extending outwardly from connector 140 on wall member 130. The opposite end of the line “L” is attached to any type of equipment suitable to assist in lifting and placing the wall members 130 onto the scaffold 112. One suitable piece of equipment for this purpose is a crane. The wall member 130 is suspended from the crane via the line “L” and the crane is used to raise and manipulate the wall member 130 via line “L”. Using the crane, the user lowers the individual wall member 130 onto a portion of the scaffold 112 or a selected ledger 122 on the scaffold 112 in the direction indicated by arrow “B” (FIG. 22) utilizing line “L”. In particular, the line “L” is used to control and place the connector 140 on the wall member 130 over one of the ledgers 122 of the scaffold 112. The line “L” is used to hold the wall member 130 in a suitable location relative to the selected ledger 122 so that the user is able to use both their hands to align the passageway 140A defined by connector 140 with the portion of the scaffold 112 or the ledger 122 and ensure that the ledger 122 is received in the aligned passageway 140A. The line “L” is then used to lower the wall member 130 relative to ledger 122 so that wall member 130 is suspended from the portion of the scaffold 112 or the selected ledger 122. Once wall member 130 is so suspended, line “L” is disconnected from wall member 130 and is connected to a next one of the wall members of the plurality of wall members 130. The first wall members 130 to be engaged with scaffold 112 are preferably engaged with the lowermost ledgers 122 of the scaffold 112, i.e., those closest to the bottom of the scaffold 112. The line “L” allows the user to lower and guide the wall members 130 into position onto the scaffold 112 without the user having to physically lift and move the wall members 130 into place using their hands. In some situations, the scaffold 112 may be placed on the side of a building during the construction or refurbishment of the building. Therefore, it is helpful and safer to have the ability to utilize equipment to lift and position the wall members 130 via the line “L” instead of the user having to try and hold and manipulate the wall members 130 a distance outwardly away from the building.

It will be understood that the user can install as many first wall members 130A or as many of the second wall members 130B in the lowermost grouping of wall members 130 as is required by the specific situation at the construction site. As the first wall members 130A or the second wall members 130B are installed they are lowered onto another portion of the scaffold 112 and the another portion of the scaffold 112 is received within the passageway 140A to allow for the first wall members 130A or the second wall members 130B to hand from the another portion of the scaffold 112.

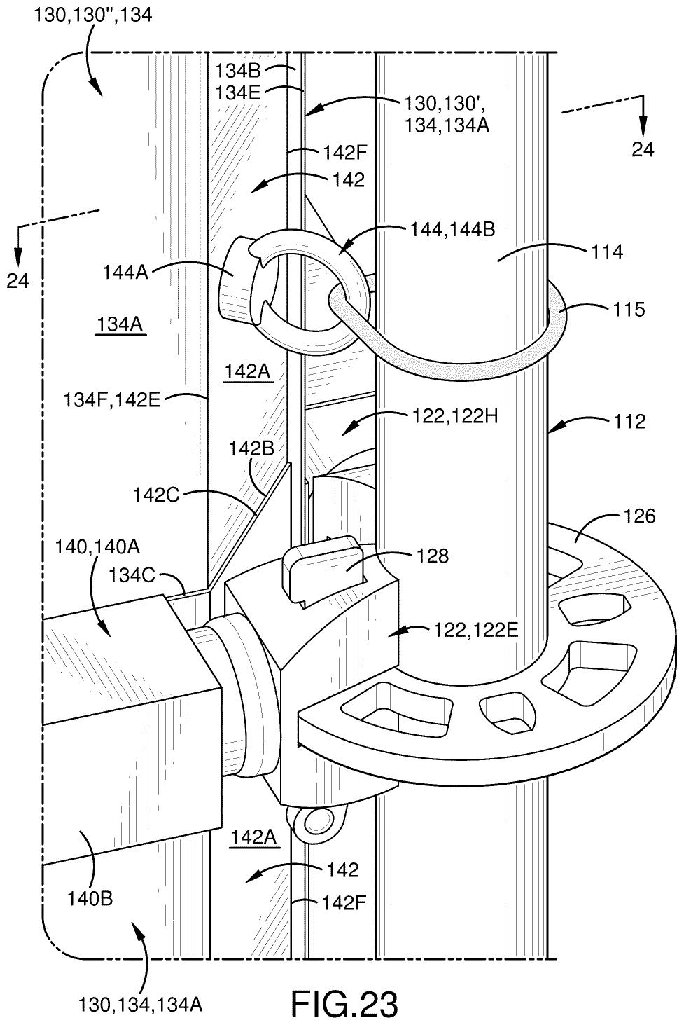

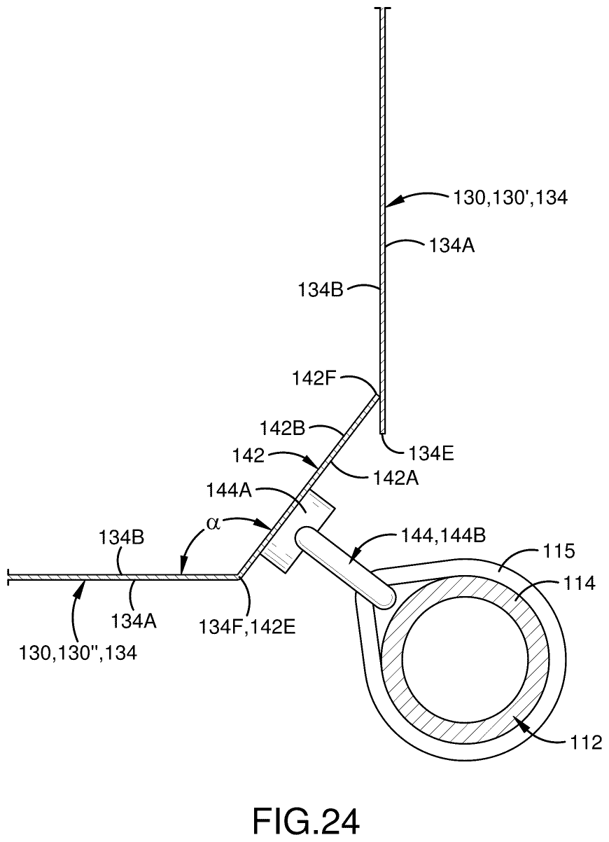

As best seen in FIG. 24, during assembly of the debris chute assembly 110, adjacent wall members 130′, 130″ are oriented orthogonal to one another. The first side 134E of one wall panel 134 of wall member 130′ is placed proximate the second side 142F of the wall flange 142 of the adjacent wall member 130″ the plurality of wall members 130. Once each of the wall members 130′, 130″ are placed or lowered onto the associated ledgers 122 of the scaffold 112, the associated line “L” will be removed from the attachment member 141 of the associated wall member 130. Each wall member 130 is then removeable secured to another portion of the scaffold 112 or the associated standard 114 by threading a tie wire 115 through the fastener 144 on the wall flange 142 of the associated wall member 130. The tie wire 115 is then looped around another portion of the scaffold 112 or around the adjacent standard 114 as illustrated in FIG. 23. The tie wire 115 is of a size and material suitable to secure the wall member 130 to the standard 114 while allowing for minimum movement of the wall member 130 relative to the standard. As best seen in FIG. 24, as tie wire 115 is tightened around the another portion of the scaffold 112 or around each of the plurality of standards 114, the second side 142F of flange 142 of wall member 130″ frictionally engages the inner surface 134B of the abutting wall member 130′ and thereby secures the first side 130E of the wall member 130′ to the scaffold 112. The arrangement also ensures there are relatively minimal gaps between adjacent wall members 130′, 130″.

It will be understood that tie wire 115 may be installed onto scaffold 112 without the use of manufactured tools such as a wrench or screwdriver, meaning that tie wire 115 can be installed with only the user's hands. The use of only the tie wire 115 to the tighten the wall member 130 to the scaffold 112 is beneficial as it is simple to install (or later remove) and requires fewer components for secure installation of the wall members 130 on scaffold 112.

It will be understood that in alternative embodiments, the tie wire 115 may be installed with the use of manufactured tools, such as a wrench or screwdriver.

When one of the second wall members 130B is lowered by line “L” onto an associated ledger 122, as is illustrated in FIG. 22, and is subsequently secured to the scaffold 112 by a tie wire 115, door 154 will be moved towards second wall member 130B in the direction indicated by arrow “C” in FIG. 22. In particular, the door 154 will be moved into a suitable position to align with aperture 152 and sheet 153. When door 154 is suitably positioned, the securement mechanism 155 is operatively engaged with the adjacent standard 114 in order to hold the door 154 in the correct position relative to the aperture 152. The door 154 is secured to the scaffold 112 by moving the at least one cuff 155C into the open position, capturing the standard 114 between the cuff 155C and base 155A, and then moving the cuff 1555C into the closed position via the hinge 155B. The cuff 155C is then locked to the base 155A via the locking mechanism 155E. As illustrated in FIG. 21, the locking of the cuff 155C and base 155A together may be accomplished by rotating the locking mechanism 155E.

After all of the wall members 130 required for debris chute assembly 10 have been positioned onto scaffold 112 and have been secured in placed, debris chute assembly 10 is ready for use. Referring now to FIG. 25, the debris chute assembly 110 is shown in use where a user opens the door 154 in a first direction indicated by arrow “E”. The user then places debris “D” into the channel 120 of debris chute assembly 110 by moving the debris “D” through the sheet 153 and the aperture 152 defined by the wall panel 134 in the direction indicated by arrow “F”. Door 154 may then be returned to the closed position by moving the door in a second direction indicated by arrow “E”. (This closing of the door 154 may be accomplished by the user pushing the door closed or the door may automatically moved to the closed position because the door 154 is biased to do this.) The debris “D” put into channel 120 then drops downwardly through the channel 120 and into a receptacle (not shown) placed beneath the lowermost wall members 130 of the debris chute assembly.

It will be understood that in order to disassemble the debris chute assembly 110, the steps set out above will simply be reversed.

It should be noted that utilizing the attachment members 141 and a line “L” makes it easy for a user to raise, lower, and otherwise manipulate the wall members 130 during the assembly and disassembly of the debris chute assembly 110. Furthermore, utilizing the fasteners 144 and the tie wires 115 helps to firmly secure the wall members 130 to the scaffold standards 114, helps to cause the wall panels 130 to help retain each other in place against the scaffold 112, and closes off gaps between adjacent wall members 130 that could allow air to flow into the channel 120 and cause movement between the wall members 130. The tie bolts 144 and wires 115 help increase the stability of the debris chute assembly 110 by firmly securing the wall members 130 to the standards 114 of the scaffold 112.

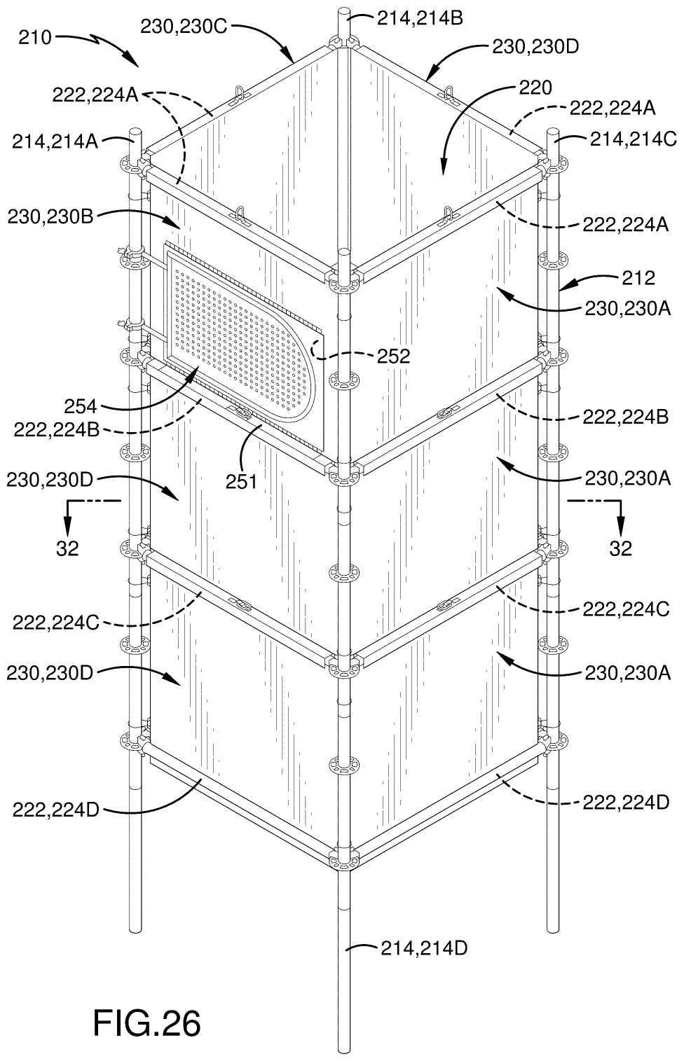

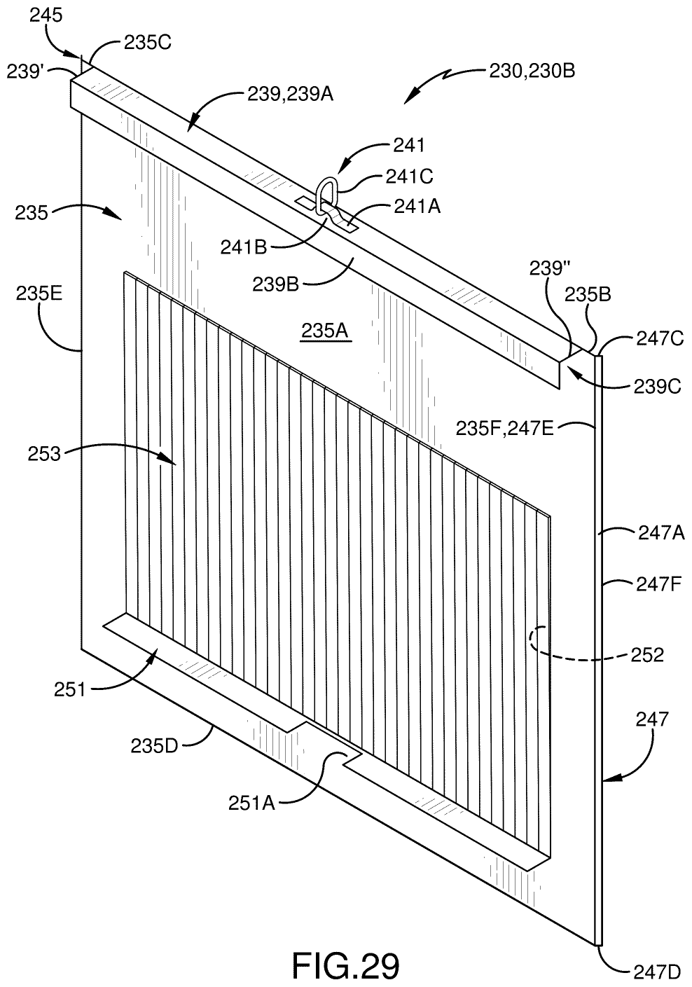

Referring now to FIGS. 26-33, there is shown a third embodiment of a debris chute assembly in accordance with the present disclosure, with the debris chute assembly being generally indicated at 210. The debris chute assembly 210 includes a scaffold 212 and a plurality of wall members 230 which are engaged with the scaffold 212. The scaffold 212 is substantially identical in structure and function to scaffold 12 of the first embodiment debris chute assembly 10 and to scaffold 112 of the second embodiment debris chute assembly 110 and will therefore not be described in much further detail herein. Scaffold 212 includes a plurality of standards 214, which are substantially identical in structure and function to the plurality of standards 14 of the first embodiment debris chute assembly 10, and to the plurality of standards 114 of the second embodiment debris chute assembly 110. Scaffold 212 further includes a plurality of ledgers 222 which are engageable with the plurality of standards 214. The ledgers 222 are substantially identical in structure and function to the ledgers 22 of the first embodiment debris chute assembly 10, and to the ledgers 122 of the second embodiment debris chute assembly 110. In particular, the standards 214 of the scaffold 212 are laterally and longitudinally spaced from one another and extend vertically between a top end and a bottom end of the scaffold 212. Each ledger 222 is coupled to and extends horizontally between a pair of adjacent standards 214 of the plurality of standards 214. The ledgers 222 are spaced a vertical distance from one another along the height of the standards 214 and are thereby arranged in a plurality of levels similar to the levels 24 of the first embodiment debris chute assembly 10. The wall members 230 of the scaffold 212 are selectively engaged with the ledgers 222 and standards 214 to form the debris chute assembly 210, as will be described in greater detail hereafter. A channel 220 is bounded and defined by the wall members 230 and the channel 220 extends from proximate the top end of the scaffold 212 to proximate a bottom end of the scaffold 212. The channel 220 is configured to allow passage of debris through the debris chute assembly 210.

Referring now to FIG. 26, debris chute assembly 210 includes a first standard 214A, a second standard 214B, a third standard 214C, and a fourth standard 214D which are oriented laterally and longitudinally relative to one another so as to form a generally square shape when debris chute assembly 210 is viewed from above. The standards 214A, 214B, 214C, 214D are arranged substantially parallel to one another and are vertically oriented when debris chute assembly 210 has been constructed.

Each ledger 222 of the plurality of ledgers 222 extends between two of the first standard 214A, second standard 214B, third standard 214C or fourth standard 214D. In particular, each ledger 222 extends between two adjacent standards 214 such that at any horizontal level of the standards 214 in scaffold 212, there are four ledgers which are arranged in opposed pairs. Referring to FIG. 26, as illustrated the plurality of ledgers 222 in scaffold 212 includes a first set of four ledgers (not numbered) which together comprise a first level 224A of ledgers, a second set of four ledgers (not numbered) which comprise a second level 224B of ledgers, third set of four ledgers (not numbered) which together comprise a third level 224C of ledgers, and fourth set of four ledgers (not numbered) which together comprise a fourth level 224D of ledgers in the scaffold 212. It will be understood that the debris chute assembly 210 includes any number of sets of ledgers which are arranged in any number of levels as dictated by the application of debris chute assembly 210.

As indicated earlier herein, debris chute assembly 210 further includes a plurality of wall members 230 which are selectively engaged with scaffold 212. As shown in FIG. 26, four wall members 230A, 230B, 230C and 230D are engaged with the first set of four ledgers of the first level 224A of ledgers 222 in the scaffold 212. Each one of the plurality of wall members 230 is engaged with one of the ledgers 222 which extends between an adjacent two of the first standard 214A, second standard 214B, third standard 214C and fourth standard 214D. It will be understood that wall members may not be engaged with every level of ledgers in debris chute assembly 210. By way of example only, in the scaffold 12 shown in FIG. 1, every alternating level of ledgers 122 is free of any engagement with any wall members 30. By way of further example only, in the scaffold 112 shown in FIG. 15, every level of ledgers 122 is engaged with four wall members 130. By way of example, only, in the scaffold 212 shown in FIG. 26, the fourth level 224D of the ledgers 222 is free of any engagement with any wall members 230 but in each of the first level, second level and third level of ledgers 222, all four ledgers 222 are engaged with wall members 230. The engagement of wall members 230 (or non engagement of wall members 230) with each level of ledgers 222 will be determined by the particular application in which the debris chute assembly 210 is to be used.

Referring still to FIG. 26, the plurality of wall members 230 which removeably engage the ledgers 222 of scaffold 212 includes wall members 230A, 230B, 230C, and 230D. The wall members identified with the reference numbers 230A and 230C are substantially identical in configuration to one another and will be referred to hereafter as “first wall members”. The wall member 230B is of a different configuration to that of the first wall members 230A and 230C, and will hereafter be referred to as a “second wall member” or a “hopper wall member”. The second wall member 230B differs from the first wall members 230A and 230C in that the second wall member 230B defines an aperture therein and includes a door which provides access to channel 220 therethrough. The wall member 230D is of a different configuration relative to the first wall members 230A and 230C, and to the second wall member 230B. The wall member 230D will be referred to hereafter as a “third wall member”. The first wall members 230A, 230C; and the second wall member 230B, and the third wall member 230D will be discussed in greater detail later herein.

It will be understood that each level of scaffold 212 may include zero, one, or more than one wall member 230 which is of the configuration of first wall members 230A and 230C. It will further be understood that each level of scaffold 212 may include zero, one, or more than one wall member 230 which is configured as second wall member 230B. It will further be understood that each level of scaffold 212 may include zero, one, or more than one wall member 230 which is configured as third wall member 230D.

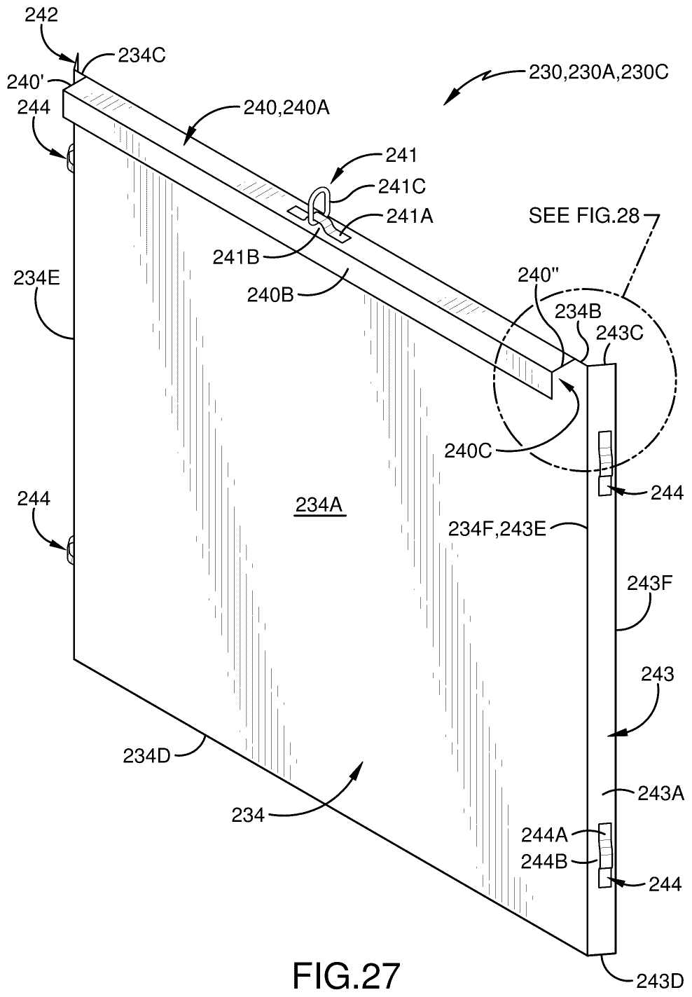

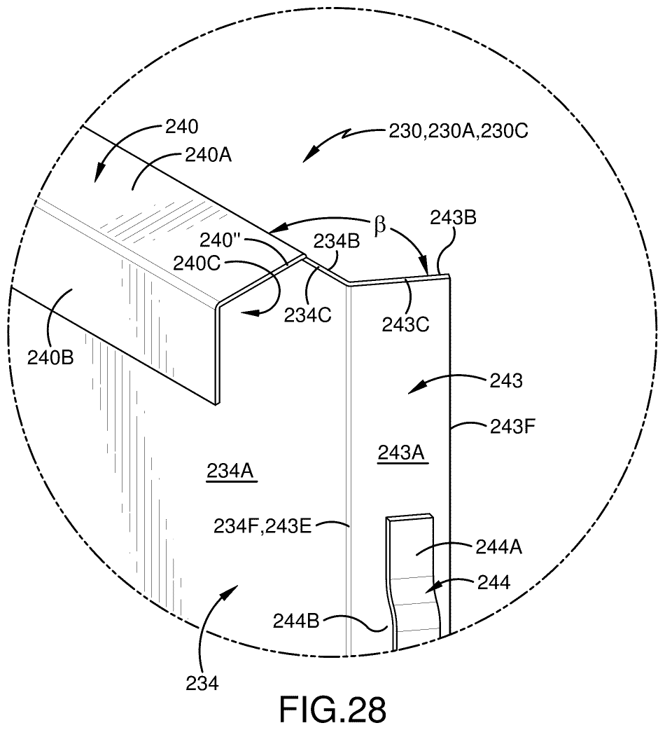

Referring to FIGS. 27 and 28, the first wall member 230A is shown in greater detail. (It will be understood that first wall member 230C is substantially identical in structure and function to first wall member 230A and the description of first wall member 230A applies equally to wall member 230C.)

First wall member 230A includes a wall panel 234, a hook or connector 240, a first wall flange 242, and a second wall flange 243. The wall panel 234 has an outer surface 234A and an inner surface 234B located opposite one another. The wall panel 234 also includes a top 234C and a bottom 234D located opposite one another, and a first side 234E and a second side 234E located opposite one another. The connector 240 is integral with or coupled to wall panel 234 proximate the top 234C of wall panel 234. The connector 240 extends outwardly from the outer surface 234A of the wall panel 234. The connector 240 includes a first leg 240A and a second leg 240B. The first leg 240A extends outwardly from the outer surface 234A at the top 234C of the wall panel 234. In one embodiment, the first leg 240A is oriented perpendicular to the outer surface 234A. The second leg 240B extends downwardly from the end of first leg 240A, such that the first leg 240A and the second leg 240B are arranged generally to form an L-shape. In one embodiment, the second leg 240B is oriented substantially perpendicular to the first leg 240A. An inner surface (not numbered) of the first leg 240A, the inner surface (not numbered) of the second leg 140B, and the outer surface 234A of the wall panel 234 together define a passageway 240C. The passageway 240C is configured to receive one of the plurality of ledgers 222 therein when the wall member 230 is engaged with the ledger 222. In one embodiment, the dimensions of the passageway 240C are complementary to the dimensions of the ledger 222 to be received therein. Connector 240 has an overall length measured from a first side 240′ of connector 240 to a second side 240″ thereof. The first side 240′ of connector 240 is proximate the first side 234E of the wall panel 234. The second side 240″ of connector 240 is proximate the second side 234F of the wall panel 234.

In accordance with an aspect of the present disclosure, at least one attachment member 241 extends outwardly from an outer surface (not numbered) of the first leg 240A of the connector 240. The attachment member 241 is used during assembly of scaffold 212 in a substantially identical manner to the attachment member 141 shown in FIG. 22 and described earlier herein.

The at least one attachment member 241 includes a bracket 241A integrally engaged with or coupled to the outer surface of the first leg 240A of the connector 240. The bracket 241A and the outer surface of the first ledge 240A of the connector 240 define an opening 241B therebetween. The at least one fastener 241 further includes a ring 241C extending through the opening 241A. In one embodiment, a single attachment member 241 is located approximately midway between the first side 240′ and the second side 240″ of the connector 240. It will be understood, however, that the attachment member 241 may be provided at any desired location on connector 240 and that more than a single attachment member 241 may be provided on connector 240. If more than attachment member 241 is provided on connector 240, the attachment members 241 may be provided at any suitable and desired locations on connector 240. attachment member

Referring still to FIGS. 27 and 28, the first wall flange 242 provided on wall panel 234 is integral with or coupled to first side 234E of the wall panel and second wall flange 243 is integral with or coupled to the second side 234F of the wall panel 234. It will be understood that first wall flange 242 is substantially identical in structure and function to second wall flange 243 and the description of second wall flange 243 applies equally to first wall flange 242.

Wall flange 243 includes a first surface 243A and a second surface 243B opposite one another. Wall flange 243 further includes a top 243C and a bottom 243D opposite one another. Wall flange 243 further includes a first side 243E and a second side 243F opposite one another. The first surface 243A and second surface 243B of the wall flange 243 are substantially continuous with the outer surface 234A and the inner surface 234B of the wall panel 234, respectively. The top 243C and the bottom 243D of the wall flange 243 are substantially aligned with the top 234C and bottom 234D of the wall panel 234, respectively. First side 243E of wall flange 243 is continuous with second side 234F of wall panel 234 and second side 243F of wall flange 243 is spaced a distance away from second side 234F of wall panel 234. It will be understood that in other embodiments, top 243C and/or bottom 243D of wall flange 243 may be recessed a distance inwardly (or outwardly) from top 234C and/or bottom 234D of wall panel 234, respectively. Additionally, it should be understood that wall flange 243 may comprise a plurality of smaller wall flanges that are spaced vertically from one another along second side 234F of wall panel 234.

As best seen in FIG. 28, wall flange 243 is arranged at an angle “β” relative to the wall panel 234, where the angle “β” is measured between the second surface 243B of the wall flange 243 and the inner surface 234B of the wall panel 234.

In one embodiment, the angle “β” is greater than 90 degrees. In one embodiment, angle “β” is between 105-165 degrees. More specifically, angle “β” is between 120-150 degrees. Most specifically, angle “β” is about 135 degrees.

In accordance with an aspect of the present disclosure, at least one fastener 244 extends outwardly from the wall flange 243. The fastener 244 is used to secure the associated wall member 230 to a standard 214 of the scaffold 212 in a substantially identical manner to how fastener 144 is utilized for this purpose as shown in FIG. 23 and as described earlier herein.

The at least one fastener 244 includes a bracket 244A integrally engaged with or coupled to first surface 243A of first flange 243. The bracket 244A and the first surface 243A of first flange 243 of the connector 240 define an opening 244B therebetween. In one embodiment, a single fastener 244 is located approximately midway between the top 243C and bottom 243D of first flange 243. As illustrated in FIG. 27, a first fastener 244A extends outwardly from the first surface 243A of wall flange 243 at a location closer to the bottom 243D of the wall flange 243 than to the top 243C thereof and a second fastener 244B extends outwardly from the first surface 243A of wall flange 243 at a location closer to the top 243C of the wall flange 243 than to the bottom 243D thereof. It will be understood that in other embodiments, the fastener 244 may be provided at any location along the wall flange 243. In yet other embodiments, more than a single fastener 244 may extend outwardly from wall flange 243 at any desired locations.

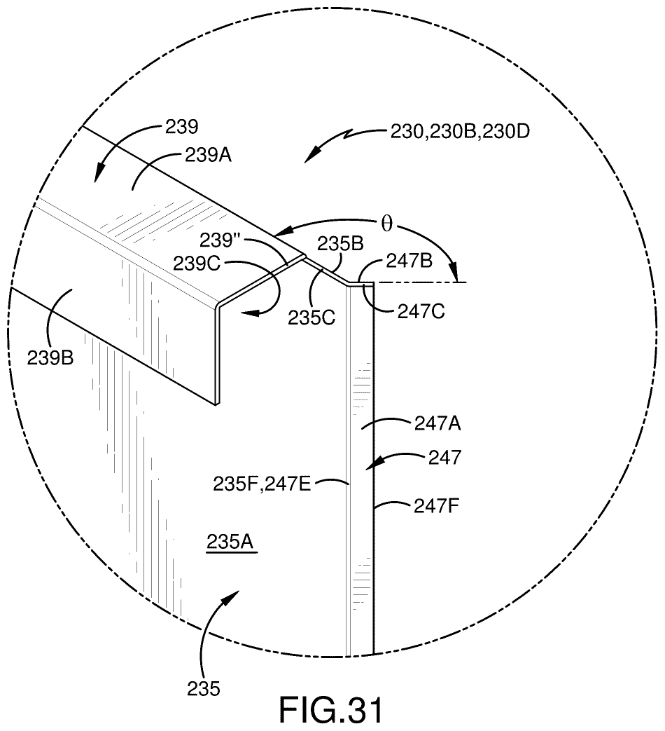

Referring now to FIGS. 26 and 31, the at least one second wall member 230B utilized in debris chute assembly 210 is identical to third wall member 230D except for the specific features discussed hereafter. Unlike the third wall member 230D, the at least one second wall member 230B defines an aperture 252 in the wall panel 235. The aperture 252 extends from outer surface 235A to inner surface 235B of wall panel. The aperture 252 is spaced a distance inwardly from each of the top 235C, bottom 235D, first side 235E, and second side 235F of wall panel 235. When the at least one second wall member 230B is engaged on scaffold 212, the aperture 252 is placed in fluid communication with the channel 220 defined in debris chute assembly 210.

The second wall member 230B further includes a shelf 251 extending outwardly from the outer surface 235A of the wall panel 235 proximate a bottom end (not numbered) of the aperture 252. The shelf 251 defines a cutout 251A extending through a portion of the shelf 251. Cutout 251A allows for a fastener 244 of a wall member 230 located in the level of scaffold 212 below second wall member 230B to be accommodated therein.

The second wall member 230B further includes a sheet 253 secured to the wall panel 235 by an appropriate securement mechanism (not shown). The sheet 253 is located so as to cover the aperture 252. The sheet 253 selectively allows access to the aperture 252 and thereby to the channel 220, as will be discussed later herein. In one embodiment, the sheet 253 is comprised of a flexible material. The flexible material may be a rubber sheet with slits cut therethrough to allow for access to the channel 220 of the debris chute assembly 210 through aperture 252. The rubber sheet may be glued or otherwise secured to the wall panel 235. Sheet 253 allows a user to insert debris into the channel 220 in the chute 210 through aperture 252 but simultaneously aids in preventing debris within the channel 220 or dust from that debris from escaping from the channel 220 of the debris chute assembly 210.

Referring now to FIG. 26, it is shown that the debris chute assembly 210 further includes a door 254 provided on second wall member 230B with the door 254 being located so as to selectively restrict access to the aperture 252 defined in second wall member 230B. Door 254 is substantially identical in structure and function to door 154 and will therefore not be described in more detail herein.

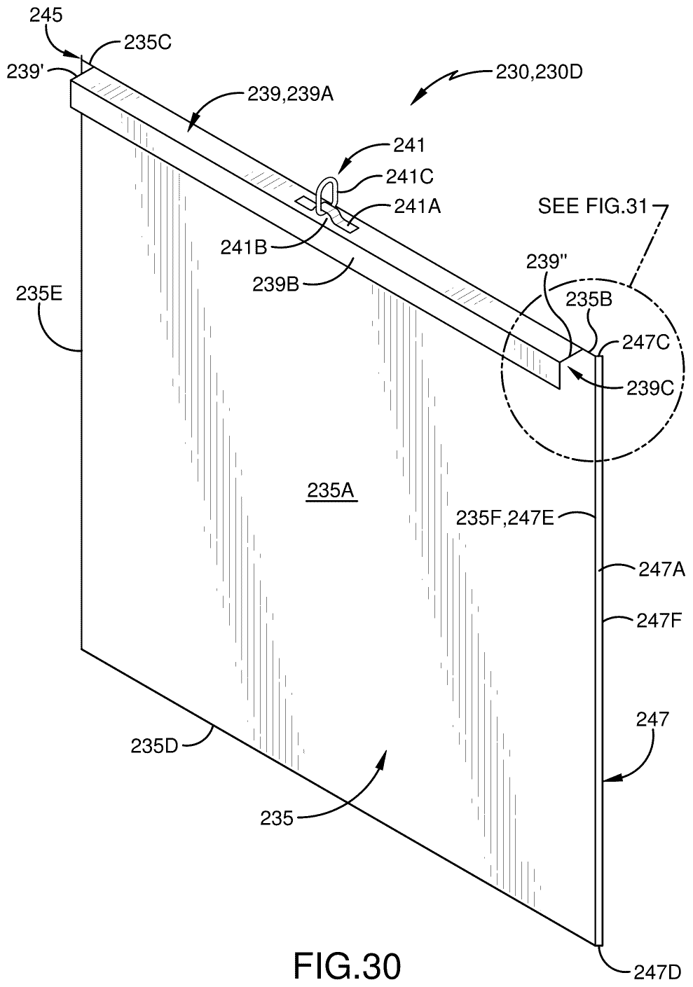

Referring now to FIGS. 30 and 31, third wall member 230D is shown in greater detail.

Third wall member 230D includes a wall panel 235, a hook or connector 239, a first lip 245, and a second lip 247. Wall panel 235 is substantially identical to wall panel 234 of first wall member 230A. The wall panel 235 has an outer surface 235A and an inner surface 235B located opposite one another. The wall panel 235 also includes a top 235C and a bottom 235D located opposite one another, and a first side 235E and a second side 235E located opposite one another.

Connector 239 is substantially identical to connector 240 of first wall member 230A. Connector 239 includes a first leg 239A and a second leg 239. An inner surface (not numbered) of the first leg 239A, the inner surface (not numbered) of the second leg 239B, and the outer surface 235A of the wall panel 235 together define a passageway 239C therebetween. The passageway 239C is configured to receive one of the plurality of ledgers 222 therein when the third wall member 230D is to be engaged with the ledger 222. In one embodiment, the dimensions of the passageway 239C are complementary to the dimensions of the ledger 222 to be received therein. Connector 239 has an overall length measured from a first side 239′ to a second side 239″ thereof. The first side 239′ is proximate the first side 235E of the wall panel 235. The second side 239″ is proximate the second side 134F of the wall panel 235.

In accordance with an aspect of the present disclosure, at least one attachment member 241 extends outwardly from an outer surface (not numbered) of the first leg 239A of the connector 239. The at least one attachment member 241 is identical in structure and function to the at least one attachment member 241 provided on first wall member 230A. In accordance with an aspect of the present disclosure, the at least one attachment member 241 extends outwardly from an outer surface (not numbered) of the first leg 239A of the connector 239 of third wall member 230D.

Referring still to FIGS. 30 and 31, the first lip 245 provided on wall panel 235 is integral with or coupled to the first side 235E of the wall panel 235 and the second lip 247 provided on wall panel 235 is integral with or coupled to the second side 235F of wall panel 235. It will be understood that first lip 245 is substantially identical in structure and function to second lip 247 and the description of second lip 247 applies equally to first lip 245.

Lip 247 includes a first surface 247A and a second surface 247B opposite one another. Lip 247 further includes a top 247C and a bottom 247D opposite one another. Lip 247 further includes a first side 247E and a second side 247F opposite one another. The first surface 247A and second surface 247B of the lip 247 are substantially continuous with the outer surface 235A and the inner surface 235B of the wall panel 235, respectively. The top 247C and the bottom 247D of the lip 247 are substantially aligned with the top 235C and bottom 235D of the wall panel 235, respectively. First side 247E of lip 247 is continuous with second side 235F of wall panel 235 and second side 247F of lip 247 is spaced a distance away from second side 235F of wall panel 235. It will be understood that in other embodiments, top 247C and/or bottom 247D of lip 247 may be recessed a distance inwardly (or outwardly) from top 235C and/or bottom 235D of wall panel 235, respectively. Additionally, it should be understood that lip 247 may comprise a plurality of smaller lips that are spaced vertically from one another along second side 235F of wall panel 235.

In one specific embodiment, lip 247 has an overall length measured from a first side 343E to a second side 343F thereof. In one embodiment, the overall length of lip 343 is about 0.5 inches.

As best seen in FIG. 23, lip 247 is arranged at an angle “θ” relative to the wall panel 235, where the angle “θ” is measured between the second surface 247B of the lip 247 and the inner surface 235B of the wall panel 235.

In one embodiment, the angle “θ” is greater than 90 degrees. In one embodiment, angle “θ” is between 95-155 degrees. More specifically, angle “θ” is between 120-160 degrees. Most specifically, angle “θ” is about 135 degrees.

It should be noted that the angle “θ” of lip 247 on third wall member 230D is complementary to the angle β of second flange 243 on first wall members 230A, 230C as the lip 247 and second flange 243 will abut one another when scaffold 212 is assembled.

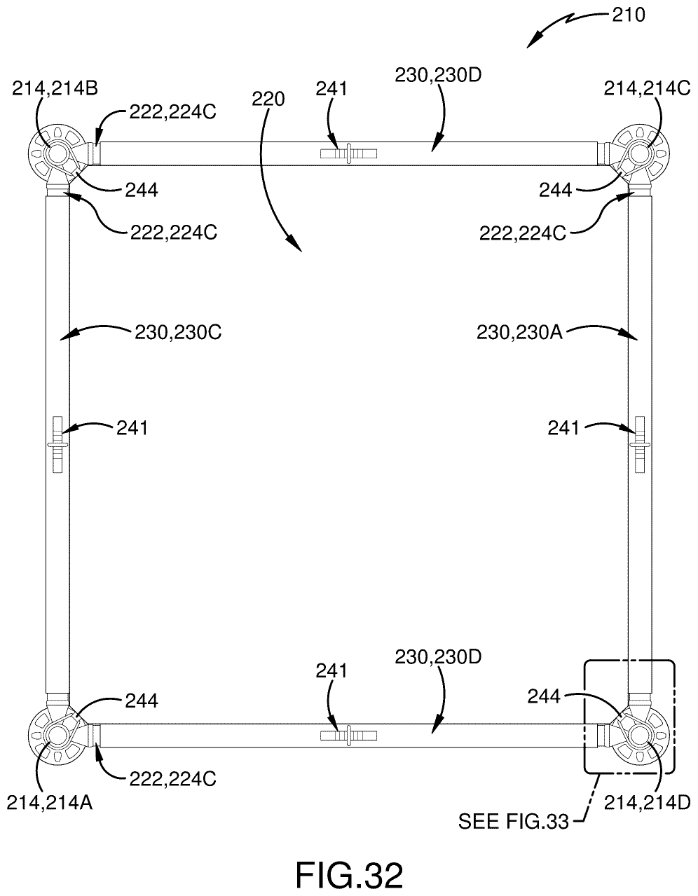

Referring to FIGS. 26 and 32, it will be noted that when debris chute assembly 210 is assembled, the inner surfaces of the wall panels 234, 235, the flanges 242, 243, and the lips 245, 247 of the plurality of wall members 230A, 230B, 230C, 230D together bound and define the channel 220 of the debris chute assembly 210.

It will be understood that the method of assembling and utilizing debris chute assembly 210 is substantially similar to the method of assembling and utilizing debris chute assembly 110 described above and therefore will not be described in much detail hereafter other than what is described below.

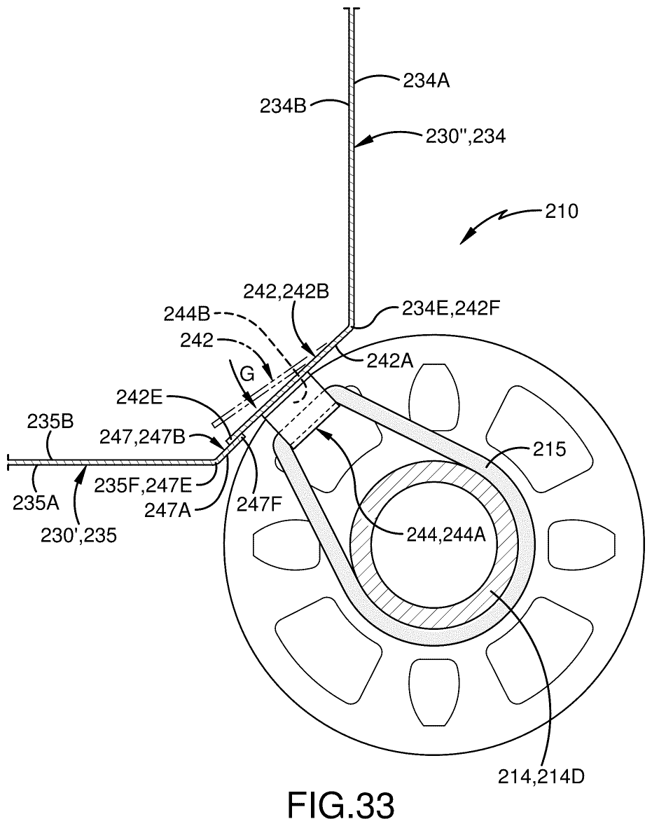

Referring now to FIG. 33, adjacent wall members 230′, 230″ are oriented orthogonal to one another. Wall member 230′ as shown in FIGS. 26 and 33 may be either of a second wall member 230B or a third wall member 230D. Wall member 230″ as shown in FIGS. 26 and 33 is a first wall member 230A. Wall flange 242 includes a first surface 242A and a second surface 242B opposite one another. Wall flange 242 further includes a first side 242E and a second side 242F opposite one another. The first surface 242A and second surface 242B of the wall flange 242 are substantially continuous with the outer surface 234A and the inner surface 234B of the wall panel 234, respectively. First side 242E of wall flange 242 is continuous with second side 234F of wall panel 234 and second side 242F of wall flange 242 is spaced a distance away from second side 234F of wall panel 234.

FIG. 33 shows that the second side 247F of one of the lips 247 of the wall member 230′ is placed proximate a second side 242F of the wall flange 242 of wall member 230″. Once each of the wall members 230′, 230″ is placed or lowered onto the associated ledgers 222 of the scaffold 212 using a line engaged with the attachment member 241 of the wall member 230 (similar to how wall member 130 is engaged with line “L” shown in FIG. 22), the associated line “L” will be removed from the attachment member 241. Each wall member 230′, 230″ is then removeably secured to another portion of the scaffold 212 or the associated standard 214 by threading a tie wire 215 through the fastener 244 on the wall flange 242 of the associated wall member 230 in a similar manner to securement of fastener 144 on wall flange 142 illustrated in FIG. 23. Specifically, tie wire 215 is inserted into the opening 244B defined by the bracket 244A and an outer surface 242A of wall flange 242. The tie wire 215 is then looped around another portion of the scaffold 212 or around the adjacent standard 214 as illustrated in FIG. 33. The tie wire 215 is of a size and material suitable to secure the wall member 230 to the standard 214 while allowing for minimum movement of the wall member 230 relative to the standard. As best seen in FIG. 33, as tie wire 215 is tightened around the portion of the scaffold 212 (i.e., the associated standard 214), the wall flange 242 of wall member 230″ moves in the direction of arrow “G” until first surface 242A of wall flange 242 of wall member 230″ is abuts second surface 247B of lip 247 of the adjacent wall member 230′.

It will be understood that tie wire 215 may be installed onto scaffold 212 without the use of manufactured tools such as a wrench or screwdriver, meaning that tie wire 215 can be installed with only the user's hands. The use of only the tie wire 215 to the secure the wall member 230 to the scaffold 212 is beneficial as it is simple to install (or later remove) and requires fewer components for secure installation of the wall members 230 on scaffold 212.

It will be understood that in alternative embodiments, the tie wire 215 may be installed with the use of manufactured tools, such as a wrench or screwdriver.

Having now described debris chute assembly 210, a method of forming debris chute assembly 210 will be discussed.

Referring now to FIG. 26, it be understood that the plurality of wall members 230 are installed on a level by level basis. The user first lowers either second wall member 230B or wall member 230D via the line “L” (substantially identical to line “L” shown in FIG. 22) onto the fourth level 224D of the plurality of ledgers 222. It will be understood that the user may use any number of second wall member 230B or wall member 230D as required by the application. After the second wall member 230B or wall member 230D are lowered onto the fourth level 224D of the plurality of ledgers 222, the line “L” is removed. The user may then lower first wall members 230A, 230B onto the fourth level 224D of the plurality of ledgers 222 and remove the line “L”.

After the wall members 230A, 230B, 230C, 230D are lowered onto the fourth level 224D of the plurality of ledgers 222 the user may wrap, loop, encircle tie wire 215 around the portion of the scaffold 212, as shown in FIG. 33, as tighten the tie wire 215.

Again, the user lowers either second wall member 230B or wall member 230D via the line “L” (substantially identical to line “L” shown in FIG. 22) onto the third level 224C of the plurality of ledgers 222. It will be understood that the user may use any number of second wall member 230B or wall member 230D as required by the application. After the second wall member 230B or wall member 230D are lowered onto the third level 224C of the plurality of ledgers 222, the line “L” is removed. The user may then lower first wall members 230A, 230B onto the third level 224C of the plurality of ledgers 222 and remove the line “L”.

After the wall members 230A, 230B, 230C, 230D are lowered onto the third level 224C of the plurality of ledgers 222 the user may wrap, loop, encircle tie wire 215 around the portion of the scaffold 212, as shown in FIG. 33, as tighten the tie wire 215.

Again, the user lowers either second wall member 230B or wall member 230D via the line “L” (substantially identical to line “L” shown in FIG. 22) onto the second level 224B of the plurality of ledgers 222. It will be understood that the user may use any number of second wall member 230B or wall member 230D as required by the application. After the second wall member 230B or wall member 230D are lowered onto the second level 224B of the plurality of ledgers 222, the line “L” is removed. The user may then lower first wall members 230A, 230B onto the second level 224B of the plurality of ledgers 222 and remove the line “L”.

After the wall members 230A, 230B, 230C, 230D are lowered onto the second level 224B of the plurality of ledgers 222 the user may wrap, loop, encircle tie wire 215 around the portion of the scaffold 212, as shown in FIG. 33, as tighten the tie wire 215.

Lastly, the user lowers either second wall member 230B or wall member 230D via the line “L” (substantially identical to line “L” shown in FIG. 22) onto the first level 224A of the plurality of ledgers 222. It will be understood that the user may use any number of second wall member 230B or wall member 230D as required by the application. After the second wall member 230B or wall member 230D are lowered onto the first level 224A of the plurality of ledgers 222, the line “L” is removed. The user may then lower first wall members 230A, 230B onto the first level 224A of the plurality of ledgers 222 and remove the line “L”.

After the wall members 230A, 230B, 230C, 230D are lowered onto the first level 224A of the plurality of ledgers 222 the user may wrap, loop, encircle tie wire 215 around the portion of the scaffold 212, as shown in FIG. 33, as tighten the tie wire 215.

It will be understood that although the tire wires 215 are described as being installed after the wall members wall members 230A, 230B, 230C, 230D are installed on to the associated levels 224A, 224B, 224C, 224D of the plurality of ledgers 222, alternatively, the user can install the wall members 230A, 230B, 230C, 230D onto each of the associated levels 224A, 224B, 224C, 224D of the plurality of ledgers 222 and then install the tire wire 215 after all of the wall members 230A, 230B, 230C, 230D are installed onto the associated levels 224A, 224B, 224C, 224D of the plurality of ledgers 222.

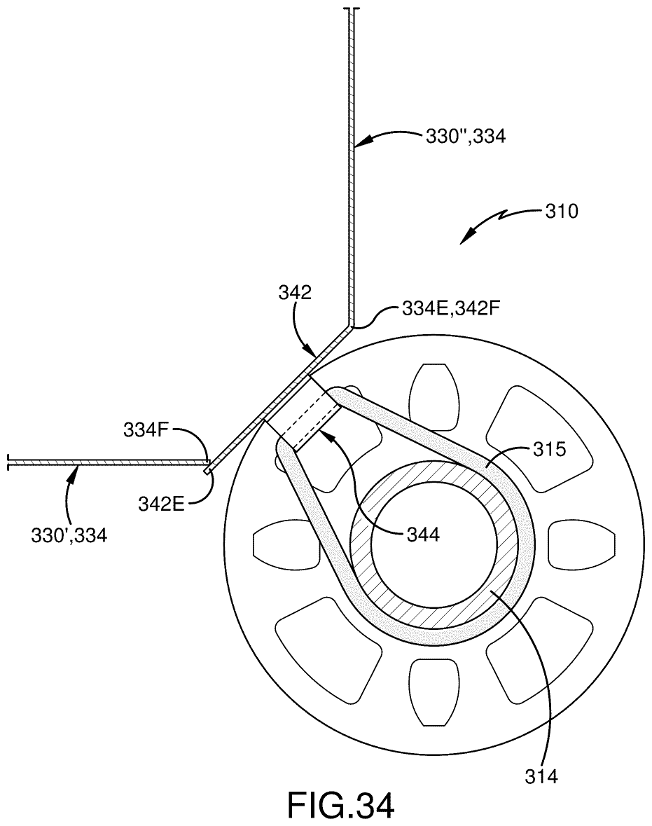

Referring now to FIG. 34, there is shown a region of a fourth embodiment of debris chute assembly, generally indicated at 310. Debris chute assembly 310 is substantially identical in structure and function to debris chute assembly 210 and will therefore not be illustrated or described in much further detail herein. Debris chute assembly 310 includes a plurality of wall members 330′ and a plurality of wall members 330″ which are engageable with a scaffold that is substantially identical to scaffold 212. Wall members 330′ include a wall panel 334 but do not include any flanges such as the flanges 242, 243 shown in FIG. 27, or lips such as lips 245, 247 shown in FIG. 30. Wall members 330″ include wall flanges 342 extending outwardly from a first side (not shown) and a second side 334E of a wall panel 334 substantially similar to wall flanges 242 and 243 shown in FIG. 27. Wall member 330″ include a fastener 344 extending outwardly from the flange 324. The fastener 344 is configured to receive a tie wire 315. Tie wire 315 is looped around a portion of a scaffold or around an adjacent standard 314 of a scaffold. As tie wire 315 is tightened around the portion of the scaffold or around the adjacent standard 314, a second side 342F of the flange 342 of wall member 330″ frictionally engages the first side 334E of the abutting wall member 330′ and thereby secures the wall member 330′ to the scaffold.

It will be understood that wall member 330′ is a variant of wall member 230′ without lips.

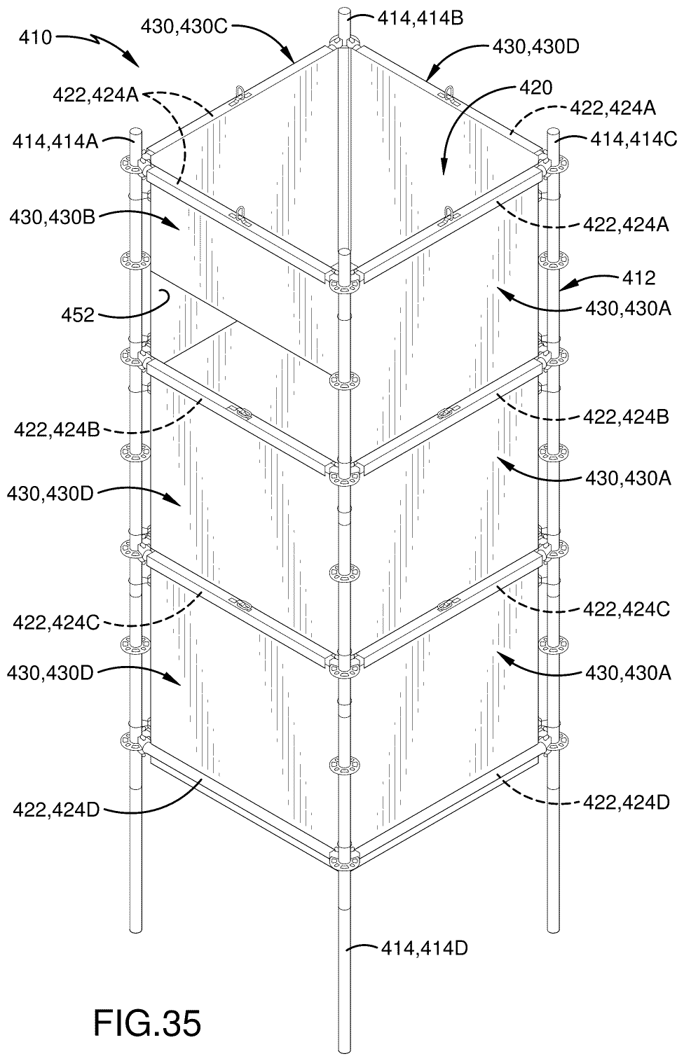

Referring now to FIGS. 35, there is shown a fifth embodiment of a debris chute assembly in accordance with the present disclosure, with the debris chute assembly being generally indicated at 410. The debris chute assembly 410 includes a scaffold 412 and a plurality of wall members 430 which are engaged with the scaffold 412. The scaffold 412 is substantially identical in structure and function to scaffold 12 of the first embodiment debris chute assembly 10, to scaffold 112 of the second embodiment debris chute assembly 110, and to scaffold 212 of the third embodiment of the debris chute assembly 210 and will therefore not be described in much further detail herein. Scaffold 412 includes a plurality of standards 414, which are substantially identical in structure and function to the plurality of standards 14 of the first embodiment debris chute assembly 10, to the plurality of standards 114 of the second embodiment debris chute assembly 110, and the plurality of standards 214 of the third embodiment debris chute assembly 210. Scaffold 412 further includes a plurality of ledgers 422 which are engageable with the plurality of standards 414. The ledgers 422 are substantially identical in structure and function to the ledgers 22 of the first embodiment debris chute assembly 10, to the ledgers 122 of the second embodiment debris chute assembly 110, and to the ledgers 222 of the third embodiment debris chute assembly 210 and will therefore not be described in much further detail herein.

In particular, the standards 414 of the scaffold 412 are laterally and longitudinally spaced from one another and extend vertically between a top end and a bottom end of the scaffold 412. Each ledger 422 is coupled to and extends horizontally between a pair of adjacent standards 414 of the plurality of standards 414. The ledgers 422 are spaced a vertical distance from one another along the height of the standards 414 and are thereby arranged in a plurality of levels similar to the levels 24 of the first embodiment debris chute assembly 10 and the levels 222 of the third embodiment debris chute assembly 210. The wall members 430 of the scaffold 412 are selectively engaged with the ledgers 422 and standards 414 to form the debris chute assembly 410, as will be described in greater detail hereafter. A channel 420 is bounded and defined by the wall members 430 and the channel 420 extends from proximate the top end of the scaffold 412 to proximate a bottom end of the scaffold 412. The channel 420 is configured to allow passage of debris through the debris chute assembly 410.

Each ledger 422 of the plurality of ledgers 422 extends between two of the first standard 414A, second standard 414B, third standard 414C or fourth standard 414D. In particular, each ledger 422 extends between two adjacent standards 414 such that at any horizontal level of the standards 414 in scaffold 412, there are four ledgers which are arranged in opposed pairs. Referring to FIG. 35, as illustrated the plurality of ledgers 422 in scaffold 242 includes a first set of four ledgers (not numbered) which together comprise a first level 424A of ledgers, a second set of four ledgers (not numbered) which comprise a second level 244B of ledgers, third set of four ledgers (not numbered) which together comprise a third level 424C of ledgers, and fourth set of four ledgers (not numbered) which together comprise a fourth level 424D of ledgers in the scaffold 412. It will be understood that the debris chute assembly 410 includes any number of sets of ledgers which are arranged in any number of levels as dictated by the application of debris chute assembly 410.

As indicated earlier herein, debris chute assembly 410 further includes a plurality of wall members 430 which are selectively engaged with scaffold 412. As shown in FIG. 35, four wall members 430A, 430B, 430C and 430D are engaged with the first set of four ledgers of the first level 424A of ledgers 422 in the scaffold 412. Each one of the plurality of wall members 430 is engaged with one of the ledgers 422 which extends between an adjacent two of the first standard 414A, second standard 414B, third standard 414C and fourth standard 414D. It will be understood that wall members may not be engaged with every level of ledgers in debris chute assembly 210. By way of example only, in the scaffold 12 shown in FIG. 1, every alternating level of ledgers 122 is free of any engagement with any wall members 30. By way of further example only, in the scaffold 112 shown in FIG. 15, every level of ledgers 122 is engaged with four wall members 130. By way of example, only, in the scaffold 212 shown in FIG. 26, the fourth level 224D of the ledgers 222 is free of any engagement with any wall members 230 but in each of the first level, second level and third level of ledgers 222, all four ledgers 222 are engaged with wall members 230. By way of example, only, in the scaffold 412 shown in FIG. 35, the fourth level 424D of the ledgers 422 is free of any engagement with any wall members 430 but in each of the first level, second level and third level of ledgers 422, all four ledgers 422 are engaged with wall members 430. The engagement of wall members 430 (or non engagement of wall members 430) with each level of ledgers 422 will be determined by the particular application in which the debris chute assembly 410 is to be used.

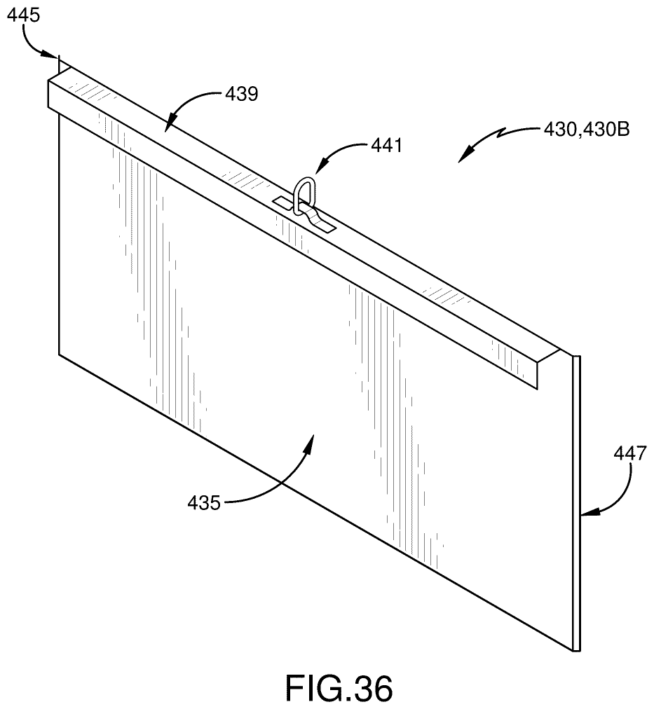

Referring still to FIGS. 35 and 36, the plurality of wall members 430 which removeably engage the ledgers 422 of scaffold 412 includes wall members 430A, 430B, 4300, and 430D. The wall members identified with the reference numbers 430A and 430C are substantially identical in configuration to one another and will be referred to hereafter as “first wall members”.

It will be understood that each level of scaffold 412 may include zero, one, or more than one wall member 430 which is of the configuration of first wall members 430A and 430C. It will further be understood that each level of scaffold 412 may include zero, one, or more than one wall member 430 which is configured as second wall member 430B. It will further be understood that each level of scaffold 412 may include zero, one, or more than one wall member 430 which is configured as third wall member 430D.

First wall member 430A is substantially identical in function and structure as first wall member 230A and therefore will be described in more detail herein. It will be understood that any description of first wall member 230A will equal apply to first wall member 430A.

Wall member 430B is a third embodiment of a second wall member 430B. Wall member 430D is a third embodiment of a third wall member. Wall member 430D is substantially identical in function and structure as third wall member 230D and therefore will be described in more detail herein. It will be understood that any description of third wall member 430D will equal apply to third wall member 430D.

Second wall member 430B includes a wall panel 435, a hook or a connector 439, at least one attachment member 441, a first lip 445, and a second lip 447. Wall panel 435 is substantially similar to wall panel 235 of third embodiment of the debris chute assembly 210 except it differs in length. Connector 439 is substantially similar to connector 239 of third embodiment of the debris chute assembly 210. At least one attachment member 441 is substantially similar to at least one attachment member 241 of third embodiment of the debris chute assembly 210. First lip 445 is substantially similar to first lip 245 of third embodiment of the debris chute assembly 210 except it differs in length. Second lip 447 is substantially similar to second lip 247 of third embodiment of the debris chute assembly 210 except it differs in length.

When second wall member 430B is installed on debris chute assembly 410 as show in FIG. 35, it defines a slot 452 which will operate similar to aperture 252 of third embodiment of the debris chute assembly 210 to allow for debris to pass through to channel 420.

It will be understood that although not pictured herein, debris chute assembly 410 may include a sheet, similar to sheet 153 in debris chute assembly 110, which is attached to a bottom edge of the second wall member 430B at the slot 452 to prevent debris or dust from escaping the channel 420 defined by the debris chute assembly 410.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, failing within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly required that there be only one of the elements.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the plurality of standards 114 being generally square relative to one another, the markers plurality of standards 114 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration relative to one another.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the device, assembly, or system of the present disclosure is described as a complete unit within the present disclosure, it is to be understood that some of the components or features detailed herein can be supplied as a retrofit kit. This approach enables the provision of only certain parts necessary to upgrade a legacy device to the specifications of device, assembly, or system of the present disclosure. Essentially, instead of requiring the replacement of the entire device, the retrofit kit allows for the selective enhancement of specific components. This could allow a user or operator to efficiently upgrade its/their existing legacy devices, systems, or assemblies to achieve the performance and functionality of the device, assembly, or system of the present disclosure without a full replacement. In the event that a component or portion of the device, assembly, or system of the present disclosure is provided as part of a retrofit kit, those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A debris chute assembly comprising:
a plurality of wall members selectively engageable with a scaffold;
a passageway defined in each wall member of the plurality of wall members;
wherein a portion of the scaffold is received within the passageway;
a flange provided on at least one wall member of the plurality of wall members;
a fastener provided on the at least one wall member; and
wherein the flange is removably securable to the scaffold via the fastener.

2. The debris chute assembly according to claim 1, further comprising:
a scaffold comprising:
a plurality of standards spaced a distance apart from one another;
a plurality of ledgers extending between adjacent standards of the plurality of standards;
wherein a ledger of the plurality of ledgers is received within the passageway; and
wherein the flange and a standard of the plurality of standards are removably securable to one another.

3. The debris chute assembly according to claim 1, wherein the at least one wall member comprises:
a wall panel having a top, a bottom, and a first side and a second side extending between the top and the bottom; and
wherein the flange extends outwardly from the first side.

4. The debris chute assembly according to claim 3, wherein the wall panel further comprises:
an inner surface and an outer surface extending between the top and the bottom; and
wherein the flange is oriented at an angle greater than 90 degrees relative to the inner surface of the wall panel.

5. The debris chute assembly according to claim 1, wherein each wall member comprises:
a wall panel having a top, a bottom and a first side and a second side extending between the top and the bottom;
a connector extending outwardly from an outer surface of the wall panel proximate the top; and
wherein the passageway is defined by the connector.

6. The debris chute assembly according to claim 5, wherein the fastener extends outwardly from an outer surface of the flange.

7. The debris chute assembly according to claim 6, further comprising:
a tie wire operably engaged with the fastener.

8. The debris chute assembly according to claim 7, wherein the tie wire extends between the portion of the scaffold and the fastener.

9. The debris chute assembly according to claim 4, further comprising:
a channel defined in the debris chute assembly, wherein the channel is bounded and defined by the inner surface of the wall panel and an inner surface of the flange of all of the plurality of wall members.

10. The debris chute assembly according to claim 9, wherein the plurality of wall members includes a first wall member and a second wall member;
wherein an aperture is defined between an outer surface and an inner surface of the second wall member; and
wherein the aperture is in fluid communication with the channel of the debris chute assembly.

11. The debris chute assembly according to claim 10, further comprising:
a door located proximate the aperture defined in the second wall panel;
wherein the door is moveable between an open position and a closed position;
wherein when the door is the open position access to the channel of the debris chute assembly is enabled; and
wherein when the door is in the closed position access to the channel of the debris chute assembly is restricted.

12. The debris chute assembly according to claim 11, further comprising:
a securement mechanism which selectively engages the door to a standard of the plurality of standards.

13. The debris chute assembly according to claim 12, wherein the door is biased into the closed position.

14. The debris chute assembly according to claim 5, wherein the plurality of wall members comprises:
a plurality of first wall members;
a plurality of second wall members; and
at least one third wall member.

15. The debris chute assembly according to claim 14, wherein the plurality of first wall members comprises:
a first flange extending outwardly from first side of the wall panel; and
a second flange extending outwardly from the second side of the wall panel.

16. The debris chute assembly according to claim 14, wherein the plurality of wall members comprises:
a first lip extending outwardly from first side of the wall panel; and
a second lip extending outwardly from the second side of the wall panel.

17. The debris chute assembly according to claim 14, wherein the third wall member is a hopper wall member.

18. A method of assembling a debris chute assembly comprising:
providing a scaffold;
providing a plurality of wall members;
defining a passageway in each wall member of the plurality of wall members;
providing an attachment mechanism proximate a top of each wall member;
selectively engaging a line with the attachment mechanism of a wall member of the plurality of wall members;
lowering the wall member of the plurality of wall members onto a portion of the scaffold;
receiving the portion of the scaffold in the passageway of the wall member; and
hanging the wall member from the portion of the scaffold.

19. The method according to claim 18, further comprising:
disengaging the line from the attachment mechanism on the wall member;
selectively engaging the line with a fastener on another wall member of the plurality of wall members;
lowering the another wall member onto another portion of the scaffold via the line;
receiving the another portion of the scaffold into the passageway of the another wall member; and
hanging the another wall member from the another portion of the scaffold.

20. The method according to claim 18, wherein providing the scaffold further comprises:
spacing a plurality of standards of a scaffold apart from one another; and
extending a ledger of a plurality of ledgers of the scaffold between adjacent standards of the plurality of standards.

21. The method according to claim 19, wherein the wall member of the plurality of wall members are lowered onto the ledger of the plurality of ledgers, the ledger is received within the passageway of the wall member, and the wall member is hung from the ledger.

22. A method of assembling a debris chute assembly comprising:
providing a scaffold;
providing a plurality of wall members;
engaging a wall member of the plurality of wall members with a portion of the scaffold;
providing a flange on the wall member;
providing a fastener on the flange;
engaging a tie wire with the fastener; and
securing the tie wire and thereby the flange and the wall member to another portion of the scaffold.

23. The method according to claim 22, wherein securing the tie wire further comprises:
threading the tie wire through an eye of the fastener;
extending the tie wire around the another portion of the scaffold;
tightening the tie wire around the another portion of the scaffold; and
securing the flange and the wall member to the another portion of the scaffold.

24. The method according to claim 23, wherein tightening the tie wire around the standard further comprises:
engaging a portion of the flange of the wall member with a portion of an adjacent wall member of the plurality of wall members; and
frictionally securing the adjacent wall member to the another portion of the scaffold.
